(19) United States
(12) Patent Application Publication
(10) Pub. No.: US 2006/0044562 A1
(43) Pub. Date: Mar. 2, 2006

(54) Gas monitor

(75) Inventors: Jon Kristian Hagene, Dilling (NO); Havard Torring, Blystadlia (NO); Ove Bjoroy, Fjellhamar (NO); Viacheslav Avetisov, Oslo (NO)

Correspondence Address: ROTHWELL, FIGG, ERNST & MANBECK, P.C., 1425 K STREET, N.W., SUITE 800, WASHINGTON, DC, 20005, US

(73) Assignee: NORSK ELEKTRO OPTIKK AS, Lorenskog (NO)

(21) Appl. No.: 10/925,146

(22) Filed: Aug. 25, 2004

(51) Int. Cl. G01N 21/17

(52) U.S. Cl. 356/437

(57) ABSTRACT

Gas detection or monitoring apparatus mainly comprising, an optical source unit including a tunable diode laser, an optical detection unit including a light sensitive detector, the source and the detector being arranged so that light from the source propagates through a gas measurement volume prior to being received by the detector, and the source being adapted to scan the light wavelength across one or more expected absorption lines of gases in the measurement volume, a control and processing unit for control and modulation of the source and processing of the detected signal and for calculating at least one digital value representing (a) gas concentrations in the gas measurement volume, wherein said control and processing unit is coupled to the source via a digital-to-analogue (D/A) converter, and the detector output signal is coupled to the input of an analogue-to-digital (A/D) converter, and the output of the A/D converter is coupled to the processing unit.

This invention in general relates to gas monitors used, for example, in the process industry.

In particular this invention relates to improvements in detection and measurement of gas concentrations and gas emissions based on tuneable diode lasers.

One of the most reliable measurement principles for continuous monitoring of gases is the use of spectroscopy. Most gases have one or more absorption lines in the ultra violet, visible or the infrared part of the spectrum. Many different spectroscopic techniques exist, but the use of single line spectroscopy utilizing tuneable diode lasers is probably the one giving best selectivity due to its high spectral resolution involving a low risk of interference from other gases.

### PRIOR ART

One example of a gas monitor based on single line spectroscopy and optical filtering techniques is described in international patent publication WO9411713 to Norsk Hydro A.S.

U.S. Pat. No. 5,637,872 to Tulip describes a gas detector of gas in a target zone where a received laser signal is used to generate a reference signal for an analogue mixer. This solution has limited performance at low signal levels.

U.S. Pat. No. 5,748,872 also to Tulip describes a gas detector for plural target zones using a time multiplexed system based on optical fibers and optical switches to send laser light through different measurement paths. This is a system for measuring at different locations, or paths, with one single instrument.

In German patent application DE 10157949 (Siemens) there is described an assembly for detecting gas leakages at a gas pipe with a defined gas measurement volume having a potentially leaked gas cloud. A tuned laser diode for emitting light and a receiver for gas detection is arranged on one side of the gas measurement volume, and a measurement window with a diffused reflective surface is arranged on the other side of the measurement volume.

The following academic publications describe direct absorption spectroscopy:
D. E. Jennings, Appl. Opt. 19, from page 2695 (1980).
D. T. Cassidy, J. Reid, Appl. Opt. 21, from page 2527 (1982).
E. D. Hinkley, Appl. Phys. Lett. 16, from page 351 (1970).

Modulation spectroscopy or harmonic detection is described in the following publications:
J. A. Silver, Appl. Opt. 31, from page 707 (1992).
E. I. Moses and C. L. Tang, Opt. Lett. 1, from page 115 (1977).
Fried, B. Henry, and J. R. Drummond, Appl. Opt. 32, from page 821 (1993).
L. C. Philippe and R. K. Hanson, Appl. Opt. 32, 6090 (1993).
M. P. Arroyo, S. Langlois, and R. K. Hanson, Appl. Opt. 33, from page 3296 (1994).
D. S. Bomse, A. C. Stanton, and J. A. Silver, Appl. Opt. 31, from page 718 (1992).
J. Reid and D. Labrie, Appl. Phys. B26, from page 203 (1981).

Reviews of TDL gas monitoring techniques are described in:
P. Werle, Spectrochimica Acta Part A 54, 197-236 (1998).
M. Feher, P. A. Martin, Spectrochimica Acta Part A 51, 1579-1599 (1995).
W. Mantz, Microchemical Journal 50, 351-364 (1994).

The following publication describes measurement of the trace gases NO2, O2 and H2O using TDL techniques:

Ultrasensitive dual-beam absorption and gain spectroscopy: applications for near-infrared and visible diode laser sensors.

Mark G. Allen et. al Applied Optics, Vol. 34, No. 18, 20 Jun. 1995, pages 3240-3249.

The following publication describes application monitoring water vapour in industrial gases and natural gas:

NEAR-IR DIODE LASER-BASED SENSOR FOR PPB-LEVEL WATER VAPOR IN INDUSTRIAL GASES SPIE Paper No. 3537-A30 William J. Kessler, Mark G. Allen, Steven J. Davis, Phillip A. Mulhall and Jan A. Polex 1998 Photonics East, SPIE International Symposium on Industrial and Environmental Monitors and Biosensors 2-5 Nov. 1998

The patent family U.S. Pat. No. 6,657,198 B1/US2004/0079887 A1 describes a system for detecting water vapour in natural gas while the following publication describes a TDL based system for monitoring H2O and CO2 for space applications: Mars laser hygrometer, C. R. Webster et. al. Applied Optics, Vol. 43, No. 22, 1 Aug. 2004, Pages 4436-4445.

The following publications describe parts of the spectral characteristics of H2S based on theoretical calculations and to some extent laboratory experiments:

Theoretical rotational-vibrational spectrum fo H2S Jörg Senekowitsch, Stuart Carter, Andre Zilch, Hans-Joachim Werner, Nicholas C. Handy, Pavel Rosmus. J. Chem. Phys. 90 (2), 15 Jan. 1989. Pages 783-994.

Open Path Detection of Hydrogen Sulphide S. A. Reid, S. Gillespie Proceedings Optical Sensing for Environmental Monitoring, International Speciality Conference, Atlanta, Ga., Oct. 11-14, 1993. Air & Waste Management Assosiation. Pages 381-397.

The infrared spectrum of H2S from 1 to 5 um Alexander D. Bykov, Olga V. Naumenko, Maxim A. Smirnow, Leonid N. Sinitsa, Linda R. Brown, Joy Crisp, David Crisp. Can. J. Phys. Vol. 72, 1994. Pages 989-1000.

Another publication describing high temperature measurements used tuneable diode lasers is:

TDLAS for Combustion Gas Analysis in a Steel Reheating Furnace J. Niska and A. Rensgard Proc. 2001 Joint International Combustion Symposium, AFRC-JFRC-IEA, Hawaii, 2001.

Traditional high-end tuneable diode laser systems (TDL) have been based on analogue mixers to achieve sufficient sensitivity or the ability to detect lower gas concentrations, with a correspondingly small spectral absorption. The combination of various analogue and digital components required today to realize a gas detector, results in a device with many discrete components and a fairly large electronic system. A fairly large physical volume is thus required. The component cost as well as production and adjustment cost are also high. The large number of discrete components, e.g. mixers, typically means that many parameters have to be tweaked or adjusted to achieve a satisfactory system performance, thus adding to the total cost of a gas measuring device.

It is thus an objective of this invention to provide improvements of gas monitor devices in order to improve upon the abovementioned limitations.

One aspect of the invention relates to the design and overall structure of electronic circuits for signal processing and control associated with an optical system comprising the tuneable laser source and a detector. Particular importance is attached to the feature of utilizing both the amplitude and the width of detected gas absorption lines, for the gas detection, measurement or monitoring function aimed at. Other aspects that are in part related to types of gases being of much interest in certain practical applications, are based on the scanning of at least two absorption lines belonging to one or two gases, in a common, single or double wavelength scan of the tuneable laser. Further aspects as described and claimed in this specification in various combinations contribute to novel and advantageous solutions according to the invention.

A major advantage of this invention is that the need for analogue amplifiers and analogue signal conditioning using discrete components is reduced, thus resulting in an apparatus with fewer discrete components and a corresponding reduced need for adjustment and trimming.

### SHORT DESCRIPTION OF THE INVENTION

The invention is based on a tuneable diode laser as a light source. The temperature of the diode laser is regulated using laser heating and cooling devices means as well as laser temperature measuring devices. The temperature regulation of the laser will tune the wavelength of the laser close to the wavelength of an absorption line that has been selected for the gas being monitored or to be detected.

A laser current control device controls the laser such that the optical wavelength of the laser is scanned across the absorption line of the gas. The modulation current of the laser comprises one low frequency ramp and possibly a higher frequency component that can be used for advanced signal processing algorithms. The current controlling device will typically be a microcontroller setting digital codes onto a data bus, to be converted into analogue laser current control signals.

One option for the laser temperature controller is to adjust the heating or cooling power by using pulse width modulation, PWM. Depending on the design around the laser, it could be possible to use thermal low pass filtering to smooth the actual laser temperature. Optionally an electric low-pass filter could be used. The drive circuitry could be reduced to a few discrete transistors by using PWM.

The light sensitive detector is connected directly to an analogue-to-digital (A/D) converter or via an amplifying stage to an analogue-to-digital converter.

The calculation of gas concentration consists of several steps including digital filtering and procedures for finding one or more gas absorption lines in the signal. A simple procedure may consist of low pass filtering of the signal followed by finding the derivative of the signal, then repeating the same procedure to obtain the second derivative of the signal.

In connection with this invention the shape (width and amplitude/strength) of gas absorption lines of interest, plays a very important role. To compensate for changing line width and line strength due to temperature, pressure and the presence of other gases in the sample, it is important to measure these line changes to be able to compensate for these accurately. Using traditional direct absorption techniques, it was possible to measure line features for high gas concentrations and high absorption, but due to problems with measurement of low gas concentrations and detection limits, harmonic detection was chosen as the measurement technique. Measuring line parameters is, however, not straightforward using harmonic detection and approaches using temperature and pressure as input to lookup tables or special functions outputting compensation factors is quite common in known techniques. Such compensations could lead to inaccuracies in the calculation of the gas concentration. This invention utilises direct measurement of the absorption line with high speed and high-resolution A/D converters to acquire line shape information that is utilised in addition to other digital signal processing algorithms calculating the concentration.

Gas monitoring in processes with fast changes exemplified by combustion processes in engines in vehicles, generators, ships etc. requires high time resolution measurements with updates every 20 ms or preferably faster. This leads to calculation of the concentration level more than 50 times every second and the electronics must therefore have enough processing power to handle all data acquisition, laser modulation, concentration measurement and general instrument control. All this normally necessitates the use of parallel processing in special digital hardware blocks customised to the application.

For experiments in combustion engines or in other combustion chambers the TDL based gas sensors could be used to monitor the emission or to study the detailed process steps with a high time resolution.

### DETAILED DESCRIPTION OF THE INVENTION

The invention will now be described in more detail with reference to the accompanying drawings where

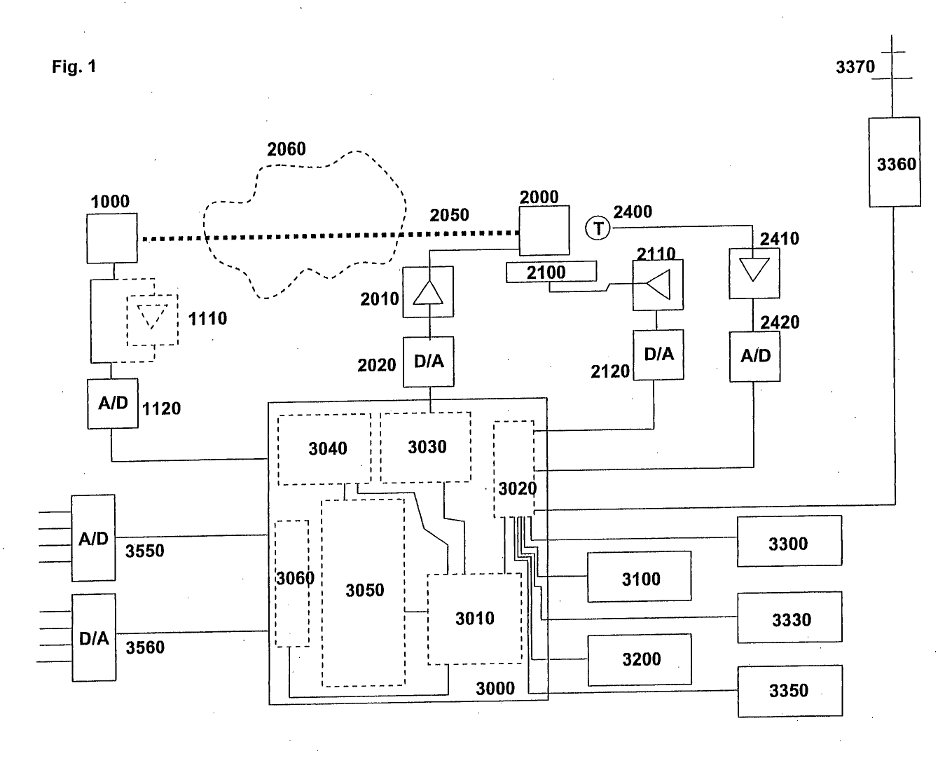

FIG. 1 illustrates a schematic view of an example embodiment of the gas monitor according to the present invention.

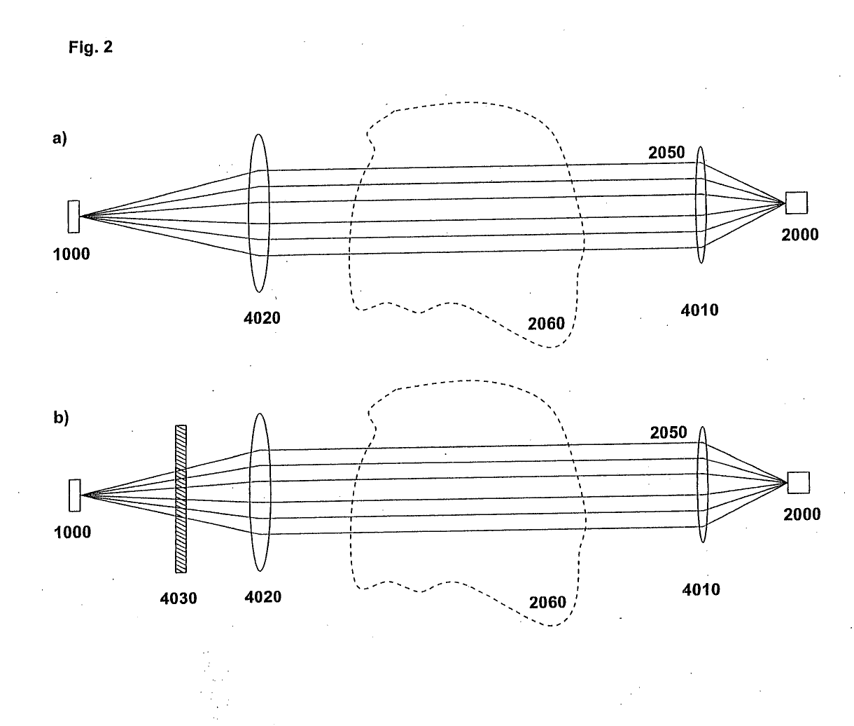

FIG. 2 illustrates the optical part of a gas monitor according to the invention.

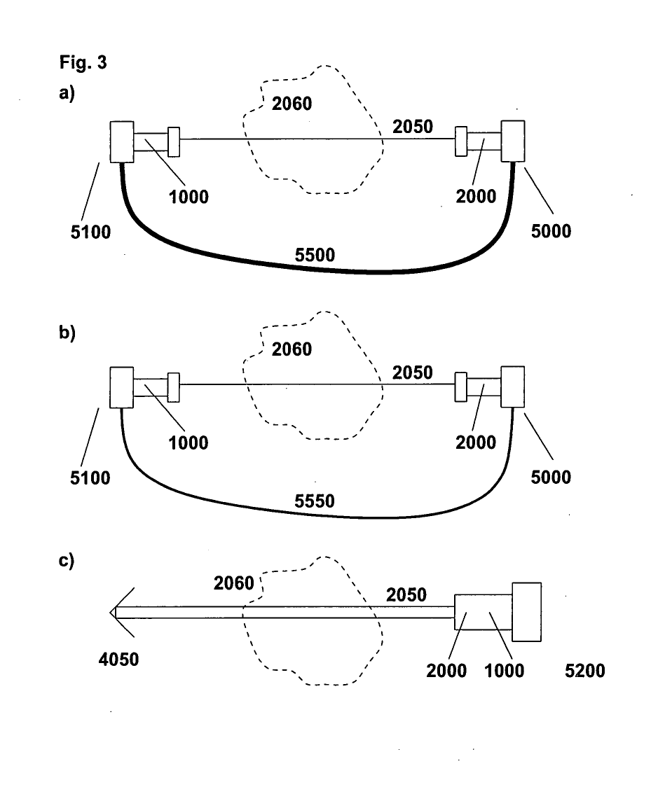

FIG. 3a shows a monitor according to the invention with a conventional transmitter/receiver with the electronics split between the two units.

FIG. 3b depicts a monitor according to the invention using optical fibers for communicating digital signals between modules.

FIG. 3c illustrates a monitor according to the invention having a dual path or open path configuration.

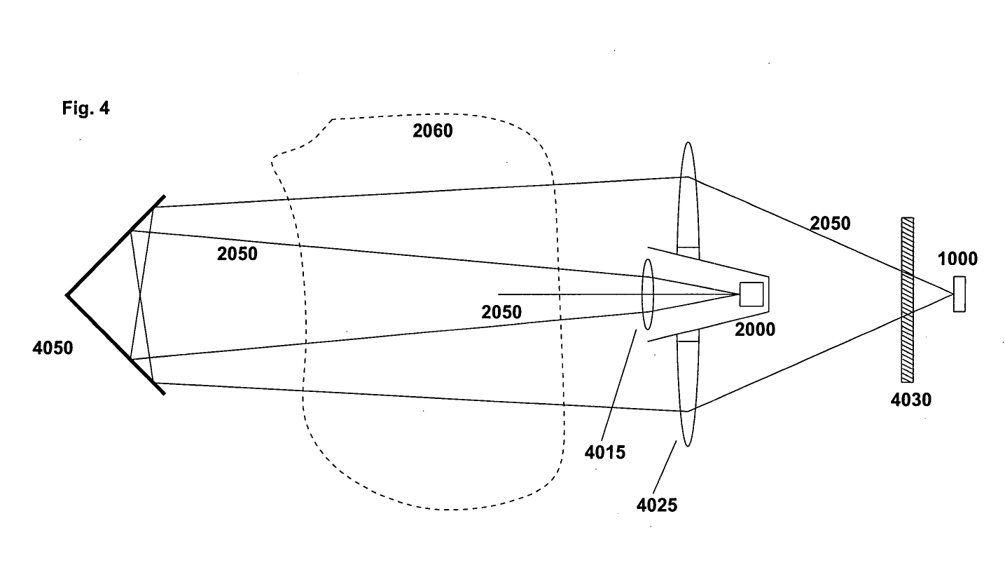

FIG. 4 shows the details of the optical arrangement using a retro-reflector, dual path or open path design.

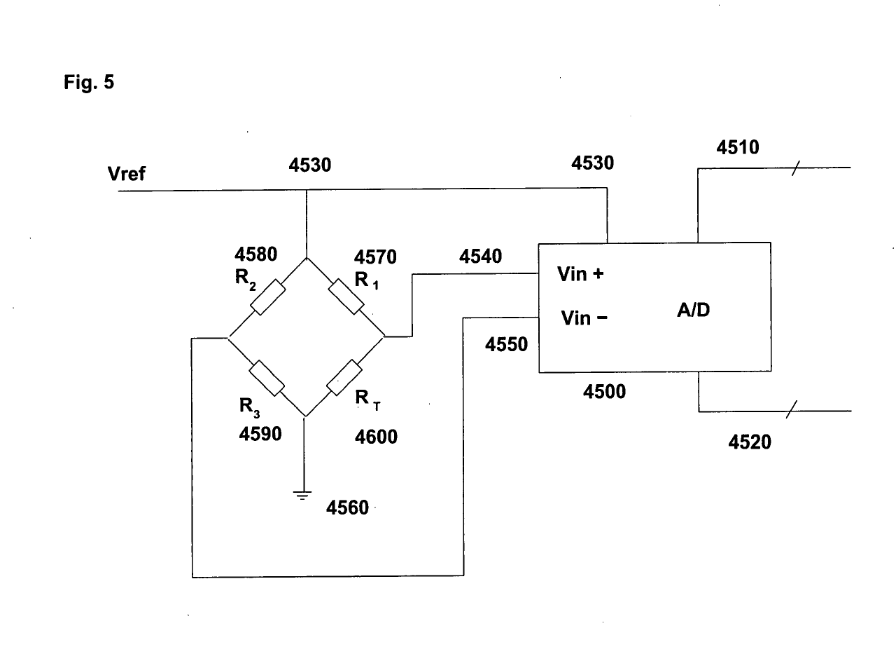

FIG. 5 is a schematic of a Wheatstone bridge circuit for the temperature measurement in the monitor according to the invention.

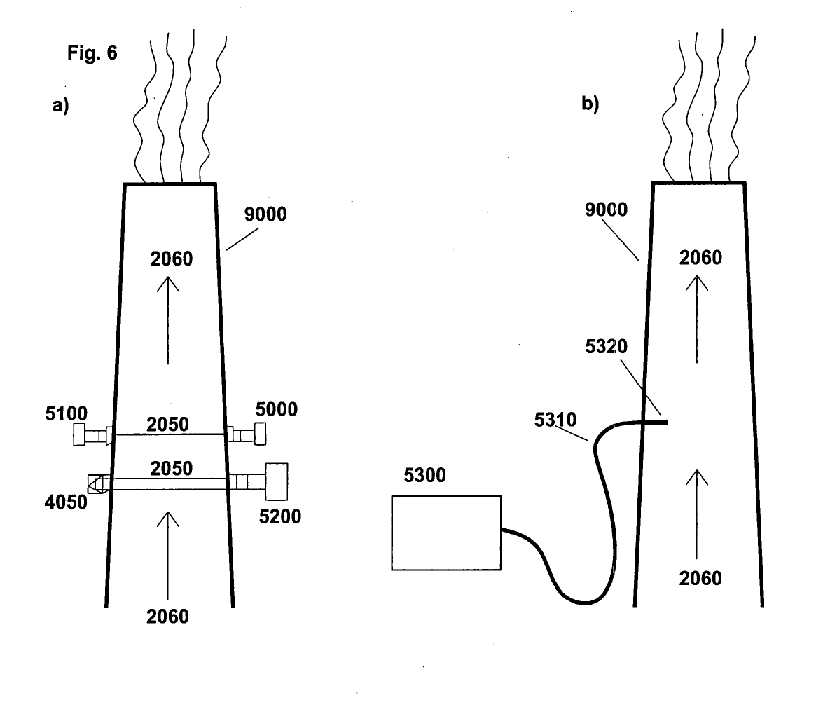

FIG. 6a illustrates an in-situ installation of a gas monitor according to the invention in a gas emitting stack.

FIG. 6b illustrates an extractive set-up of a gas monitor according to the invention in a stack emitting gas.

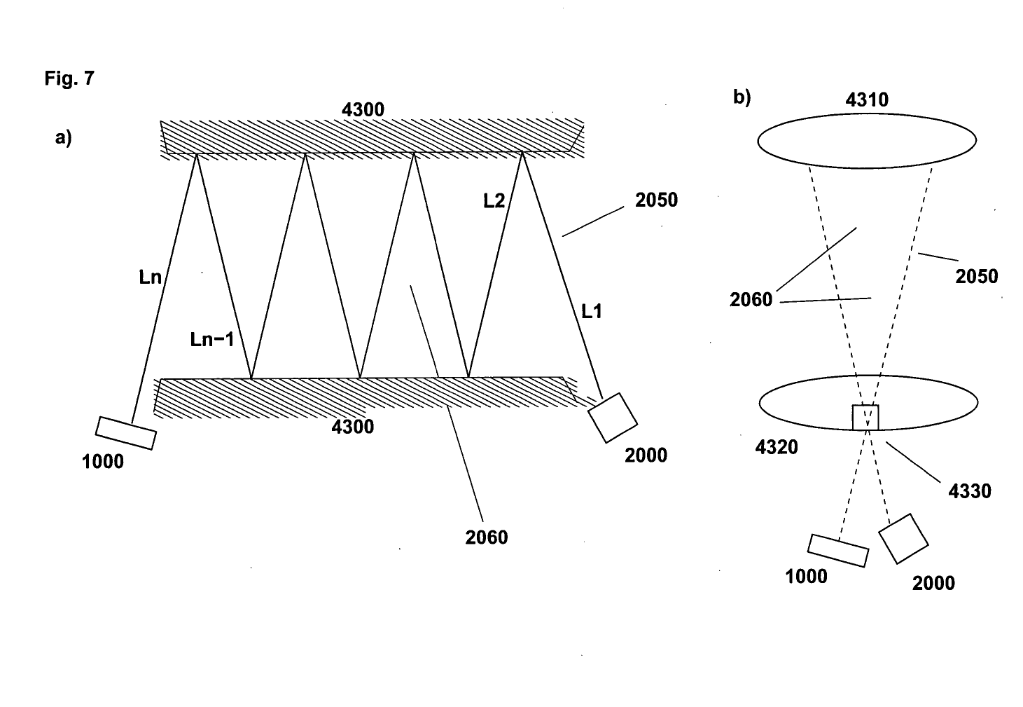

FIG. 7a shows the principle of a multi-pass cell designed to give a long effective optical path length in the gas monitor according to the invention.

FIG. 7b shows a simplified sketch of a Herriott cell based on the same principle as shown in FIG. 7a.

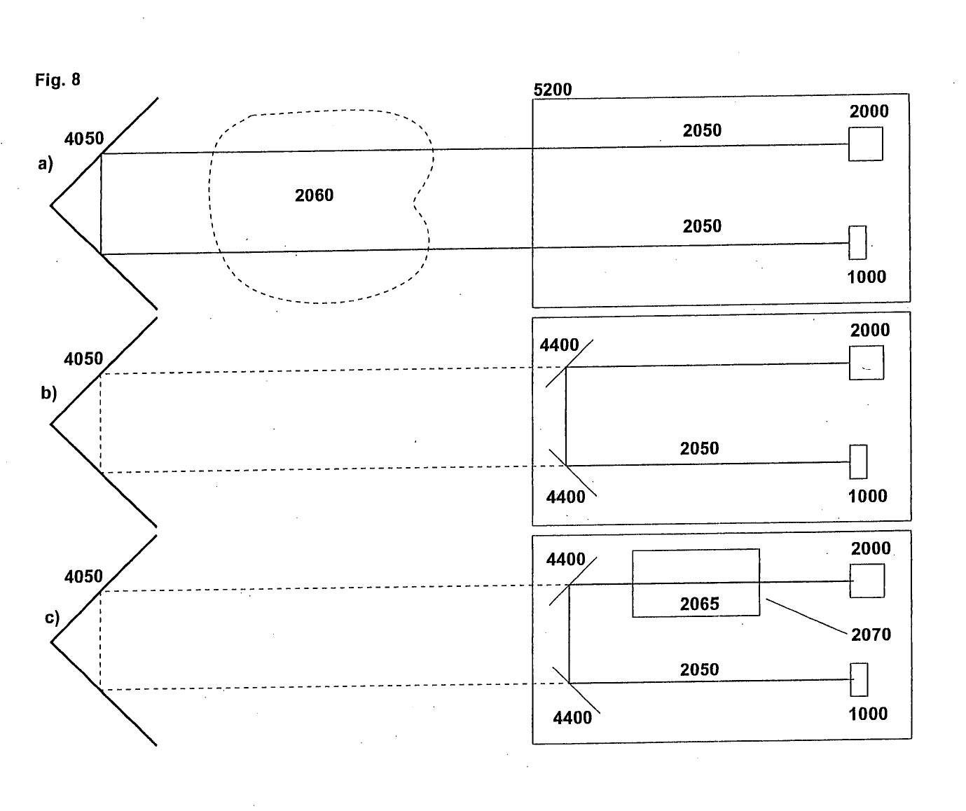

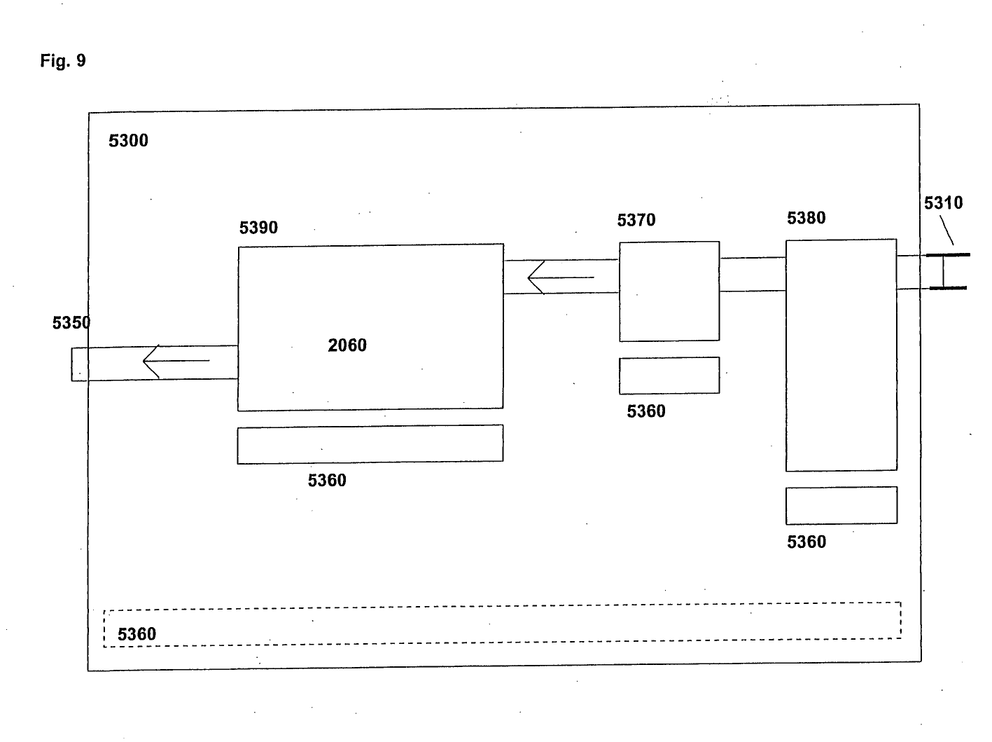

FIG. 8 shows a dual gas monitor configuration according to the invention for
a) normal measurement
b) zero check
c) span check

FIG. 9 illustrates the gas flow inside an extractive system configuration of an extractive gas monitor according to the invention.

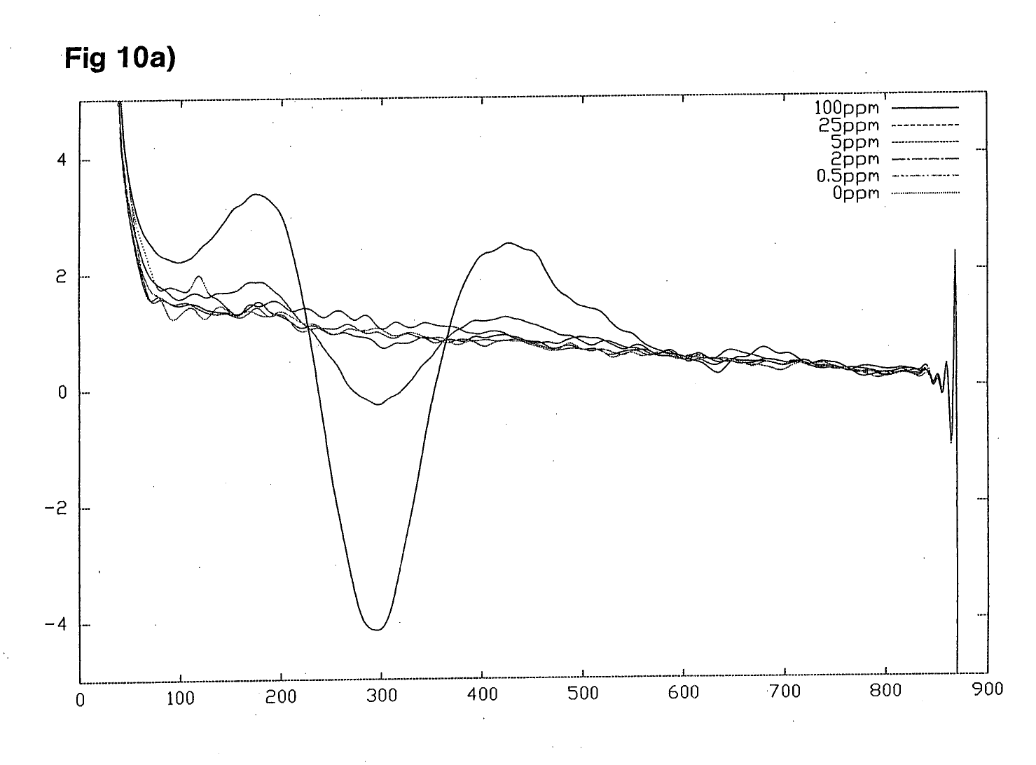

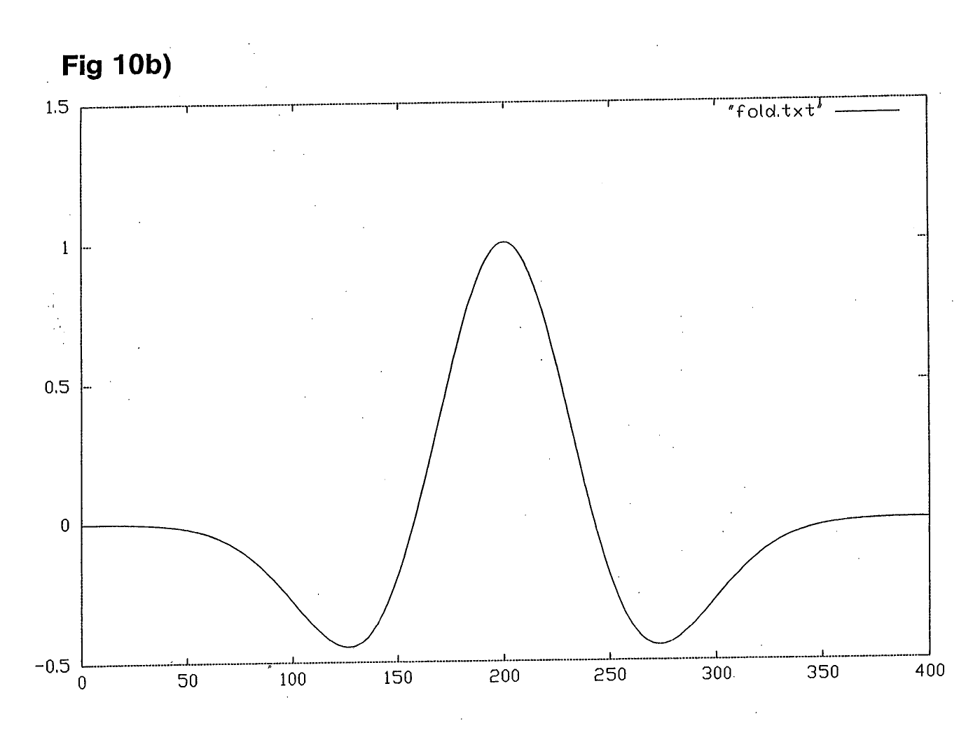

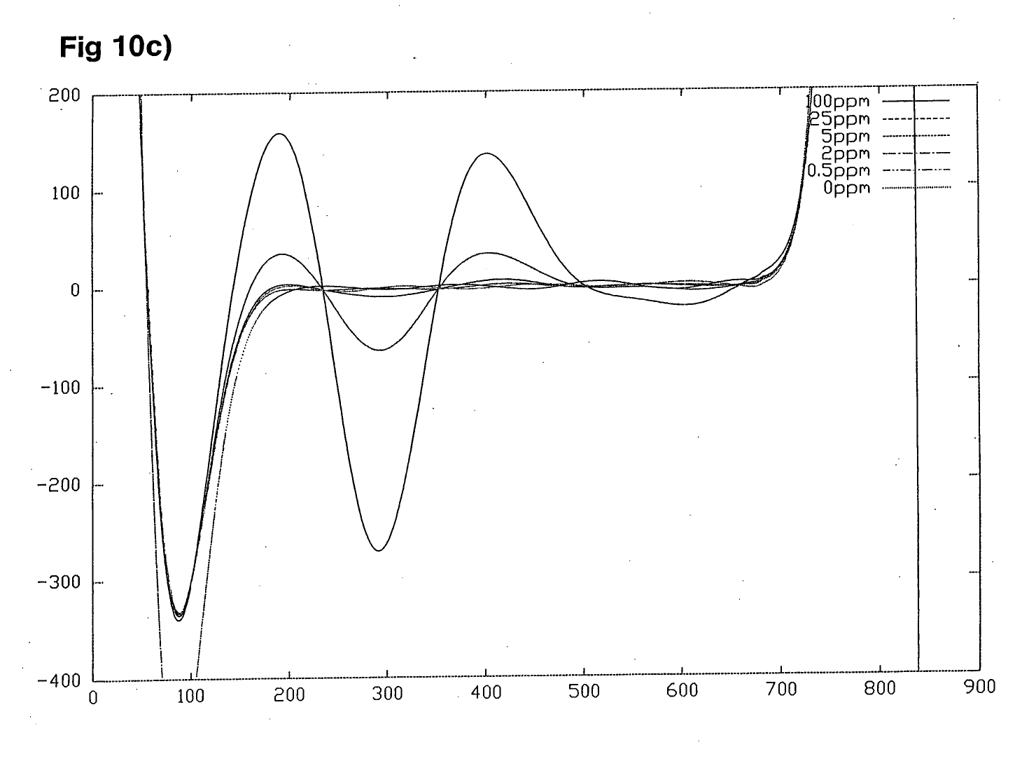

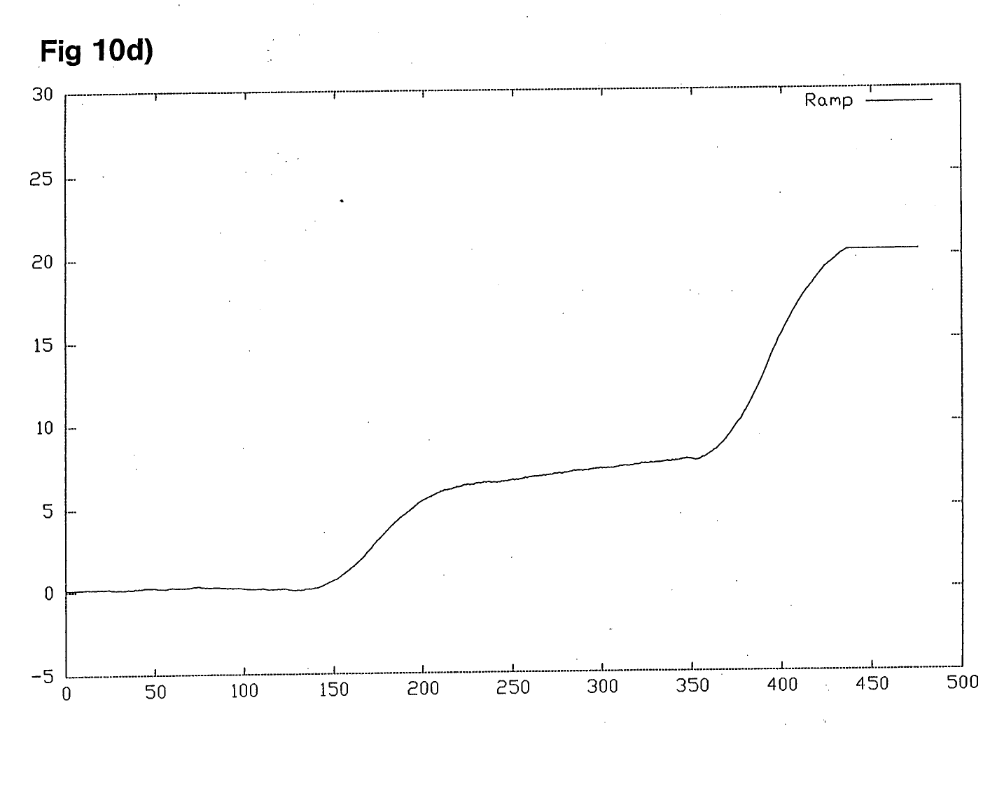

FIG. 10a illustrates a typical measurement signal in a monitor according to the invention after the initial processing for several different gas concentrations.

FIG. 10b shows one possible convolution function for use in the signal processing of the monitor according to the invention.

FIG. 10c shows the measurement signals of FIG. 10a after convolution with the function of 10b.

FIG. 10d shows the measured concentration of ammonia obtained in a calibration cell purged with different concentrations of calibration gas.

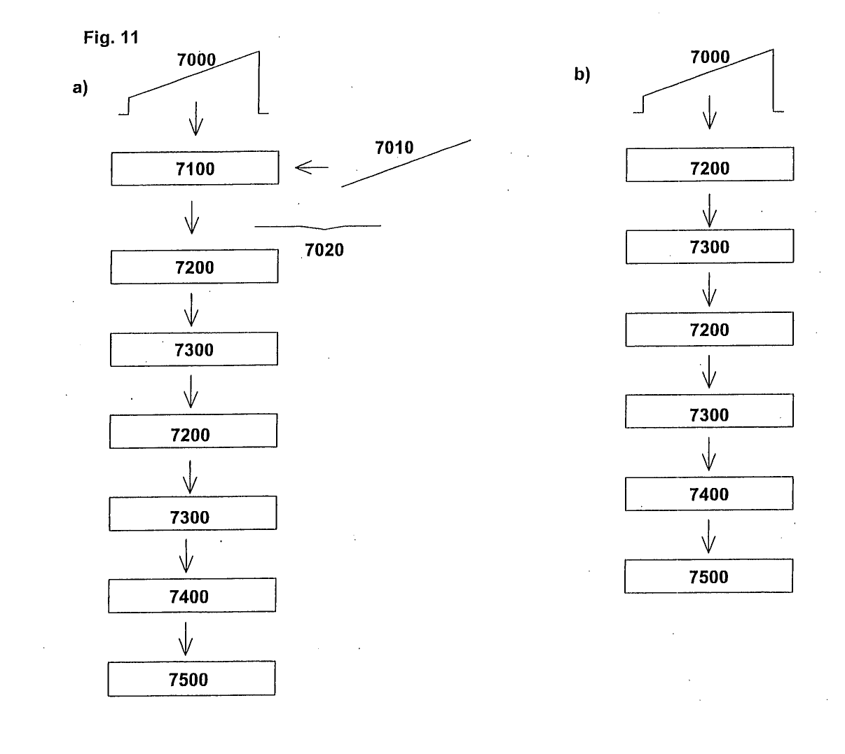

FIG. 11a-b shows the process steps of two possible methods for concentration calculation in a monitor according to the invention.

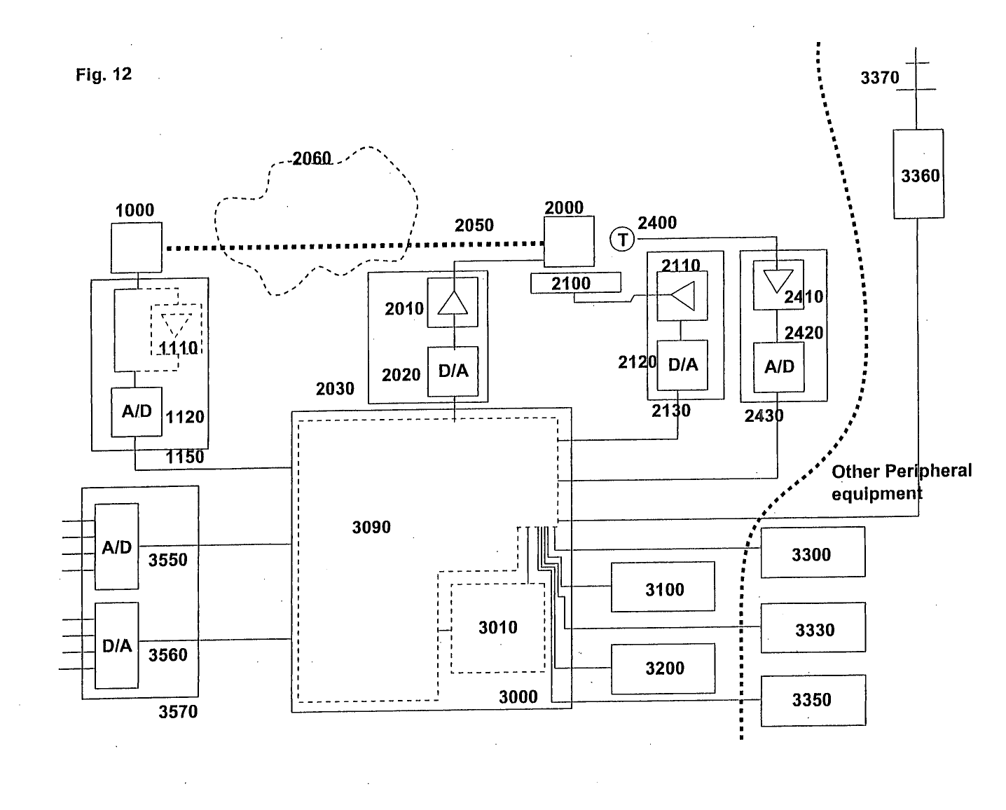

FIG. 12 illustrates a schematic view of an alternative embodiment of the gas monitor according to the present invention.

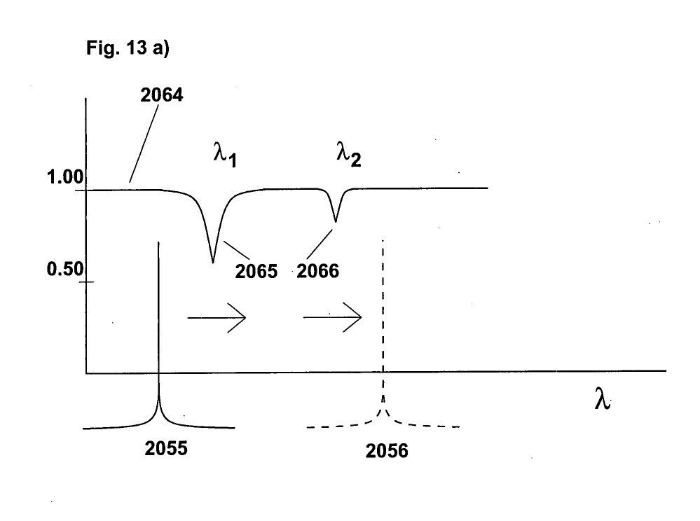

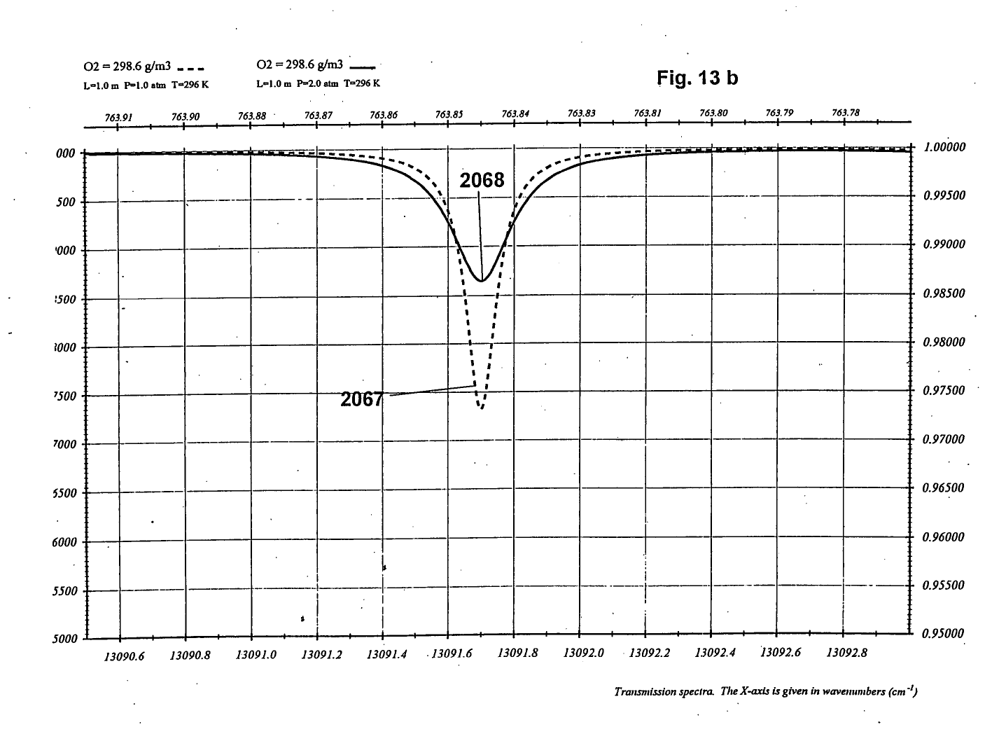

FIG. 13a shows a section of a simplified absorption spectrum with typical absorption lines resulting from two gases.

FIG. 13b shows line broadening effects of absorption lines.

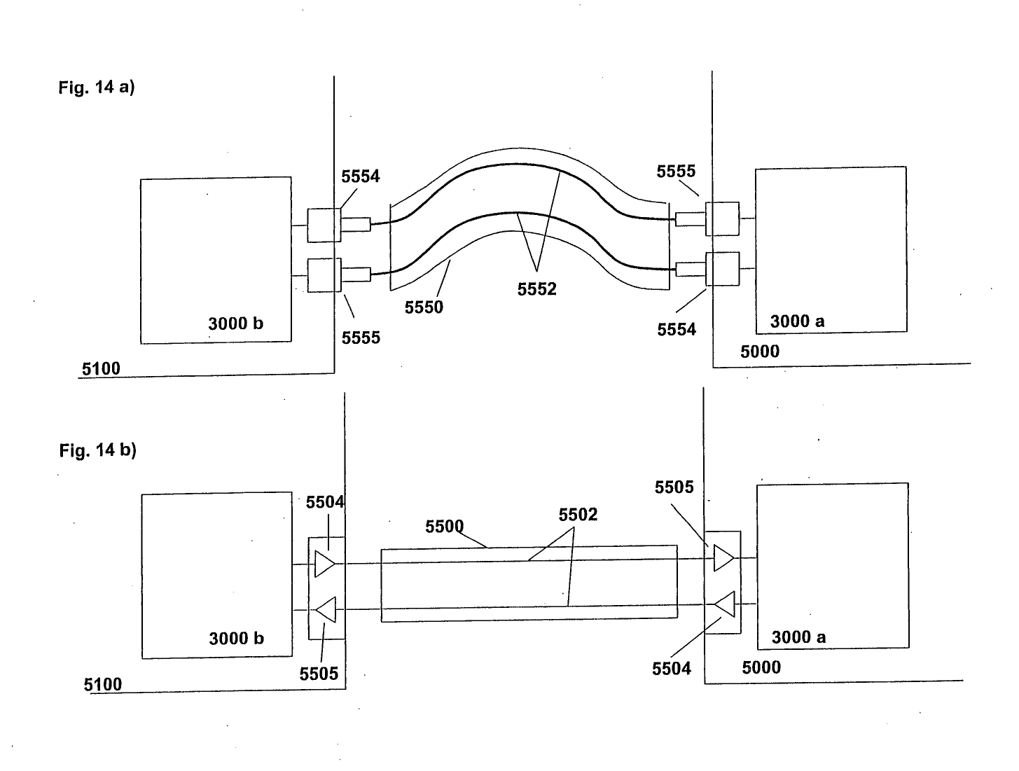

FIG. 14 illustrates the transmitter and receiver parts and the communication between these in a gas monitor according to the invention.

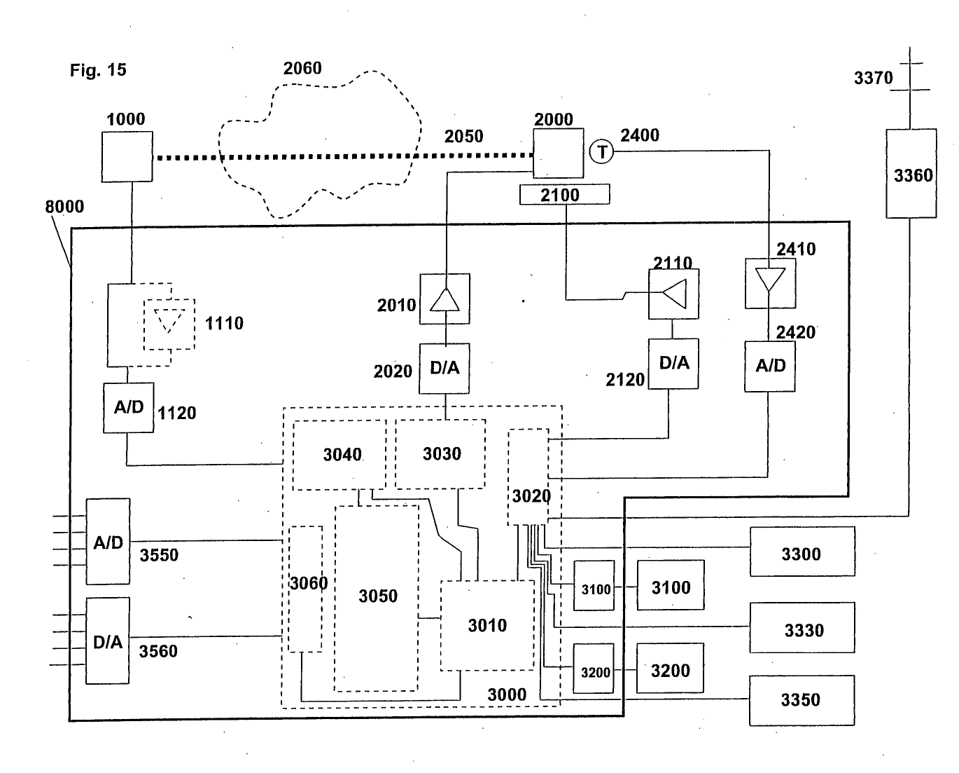

FIG. 15 shows a further embodiment of gas monitor electronics according to the invention.

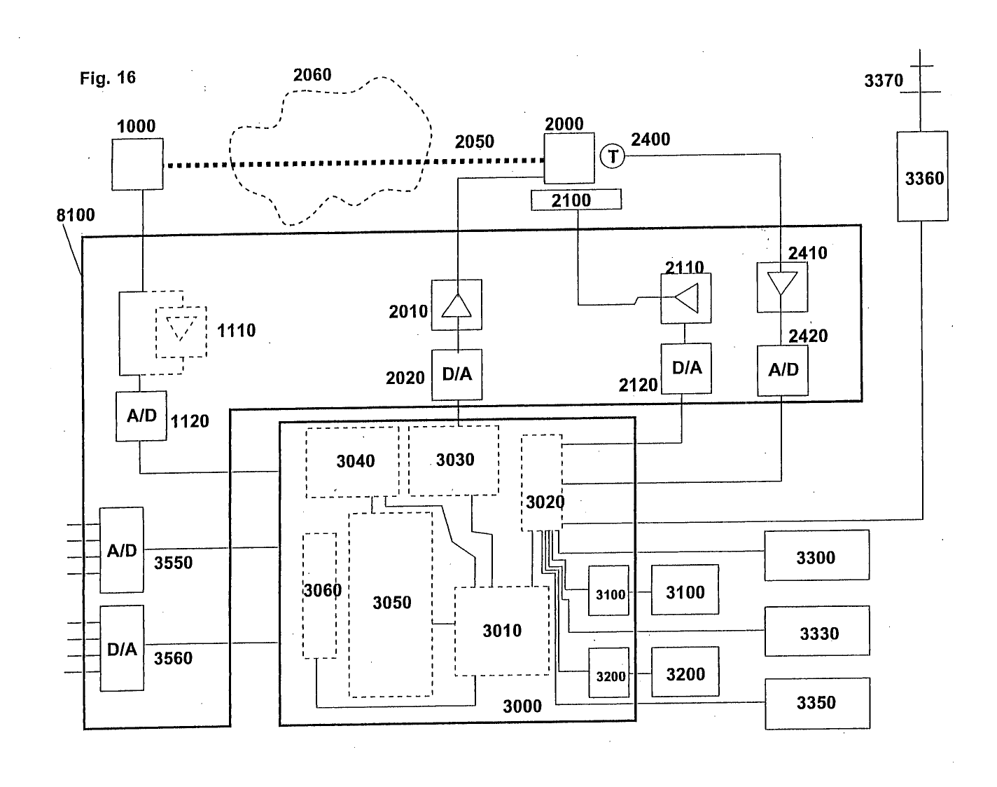

FIG. 16 shows still another embodiment of gas monitor electronics according to the invention.

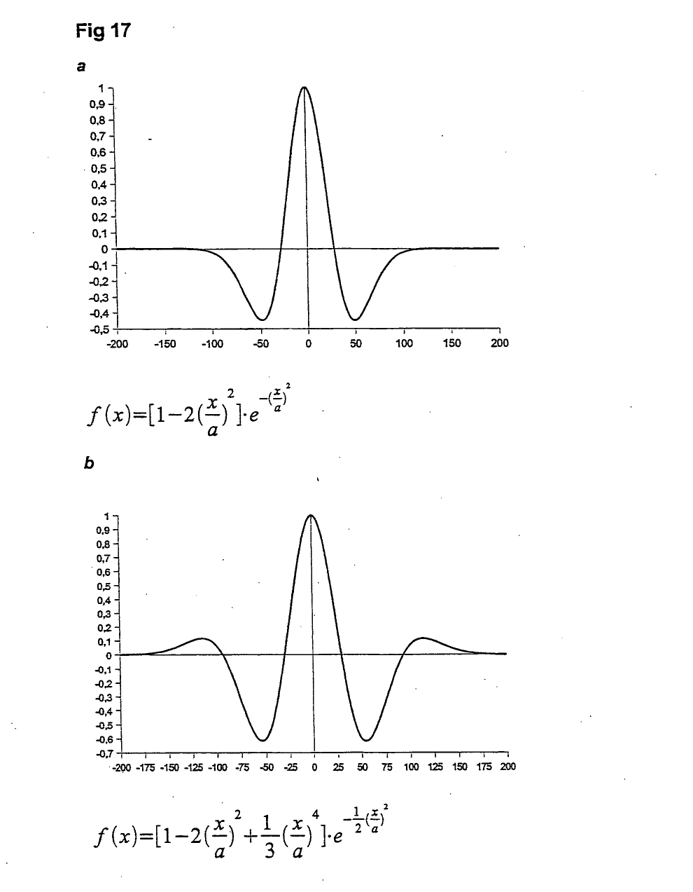

FIG. 17 shows convolution functions used in the calculation of gas concentrations.

In the example of a gas monitor according to the invention illustrated in FIG. 1 a diode laser 2000 is heated or cooled using a heater/cooler 2100. The temperature of the laser 2000 is measured with a temperature sensor 2400. The diode laser 2000 is a tuneable laser diode.

The laser beam 2050 from the diode laser 2000 passes through a gas measurement volume 2060 and is received by a detector 1000. The gas measurement volume 2060 may contain a sample or amount of a gas to be detected, measured or monitored. The detector 1000 is connected to the input of an A/D converter 1120, either directly or via a detector amplifier stage 1110. The detector is arranged to detect radiation that has been transmitted from the laser diode through the gas measurement volume 2060. The detector 1000 is preferably a photoelectric sensor. The detector is preferably a photo or PIN diode, preferably realized in Si or InGaAs, however InSb, CMT/MCT (cadmium mercury telluride) or any other material combination for making photodiodes known to those skilled in the art, could also be used. Typically the photodiode will be provided with a reverse bias arrangement. An optical detector will be coupled to a high-speed (typically 10-200 kHz), high-resolution A/D converter, optionally via a preamplifier stage. The A/D converter could for example be a switched capacitor type converter. Other types of converters could also be used, such as sigma-delta converters or SAR (Successive Approximation Register) converters. In order to avoid analogue operational amplifiers, A/D converters having switched capacitor input stages can be used. However, the A/D conversion is not necessarily based on the switched capacitors.

FIG. 2a shows the main parts of the optical system which is a part of the monitor according to the invention. FIG. 2 shows the arrangement of the tuneable diode laser 2000, the beam shaping optics which collimates the laser beam 2050 or makes the laser beam 2050 a conical beam. In a preferred configuration the optical system comprises only one lens.

The laser beam 2050 is directed towards the gas measurement volume 2060 and the beam is collected by the detector optics system 4020 and focused onto the detector 1000.

In an optional implementation, as illustrated in FIG. 2b, an optical band pass filter 4030 with a centre wavelength around the laser wavelength stops unwanted IR radiation from high temperature gas(es) within the measurement volume 2060 with and without significant dust loads. The blocked IR radiation could otherwise saturate the detector.

FIG. 3 illustrates three different configurations of the monitor. FIG. 3a shows a conventional transmitter 5000 and receiver 5100 with the electronics split between these transmitter and receiver modules. Traditional systems use a cable 5500 between the transmitter and the receiver for both analogue and digital signals, but in this invention only digital signals are sent between the two units.

FIG. 3b shows a transmitter/receiver solution with optical fibers 5550 used for digital signals between the transmitter and receiver modules. The communication will normally be two-way, but configurations using one-way communication are also possible.

FIG. 3c illustrates an optical system for use in a monitor according to the present invention having a dual path or open path configuration. A transceiver solution with a retro-reflector 4050 doubles the optical path length through the gas and therefore increases the sensitivity of the instrument.

FIG. 4 illustrates the optical details of a retro-reflector design, dual or open path. Light from the laser 2000 is collimated or shaped into a conical beam using an optical system 4015. The optical system 4015 is in a preferable embodiment according to the invention a single lens. The laser beam 2050 propagates through the gas measurement volume 2060 and is reflected by the retro-reflector 4050 and passes through the gas measurement volume 2060 again before it is collected by detector optics 4025 and focused onto the detector 1000. For high temperature applications an optical band pass filter 4030 is inserted to prevent the detector 1000 from saturation.

FIG. 5 is a schematic of a Wheatstone bridge circuit used for laser temperature measurement. A thermistor 4600 is connected together with resistors 4570, 4580. 4590 with low thermal drift. Both the bridge and the voltage reference input on the AID converter 4500 are fed by the same reference voltage 4530. This is to assist in reducing the noise in the measurement. An A/D converter data bus 4510 and a control signal bus 4520 are also illustrated, serving to download data from the A/D converter and to control the A/D converter respectively.

FIG. 6a illustrates the in-situ arrangement of a gas monitor according to the present invention in a stack 9000 emitting gas 2060. An upper gas monitor set comprises a transmitter 5000 which sends laser light 2050 trough the sample gas 2060, the laser light being collected by the receiver 5100. The upper monitor set is a arranged in a single path configuration.

The lower gas monitor set is arranged in a dual path configuration having a transceiver unit 5200 emitting laser light 2050 being directed through the sample gas 2060 and being reflected by a retro-reflector 4050 or a reflective sheet. The laser light passes through the gas measurement volume 2060 twice.

FIG. 6b shows an extractive set-up in a stack 9000 emitting gas 2060. An insertable sample probe 5320 has been placed in the stack 9000 in order to sample gas(es) in a gas from the stack. The sample of gas is transported through a pipe and hose system 5310 to a gas measurement volume (not shown in FIG. 6b, see FIG. 9) in the gas monitor 5300. The hose and pipe system could be heated by a heating arrangement to avoid condensation, chemical reactions and to avoid gas temperature changes. An extractive set-up will only be beneficial if the effective optical path length is longer in the Herriot or white cell. See further below.

FIG. 7a illustrates the principle of a multi-pass cell to be used for providing a long effective optical path length in the monitor according to this invention. The gas sample extracted from e.g. a stack is led through a cell containing two mirrors 4300. A laser light source emits laser light 2050. The direction of the beam is arranged so that the beam follows a zigzag path in a gas measurement volume 2060 before it reaches the detector 1000. The effective optical path length is the sum of L₁, L₂, . . . , Lₙ₋₁, Lₙ.

FIG. 7b shows a simplified sketch of a Herriot cell based on the same principle as shown in FIG. 7a. A Herriot cell is based on two spherical mirrors 4310 and 4320 where the volume generally between the mirrors defines a gas measurement-volume 2060. The mirror 4320 contains a cut-out 4330 so that the laser light from the laser 2000 will enter the cell and so that the reflected beam will reach the detector 1000. Only some parts of the laser beam 2050 have been illustrated.

FIG. 8 shows a dual gas monitor configuration for normal measurement (FIG. 8a), zero checking (FIG. 8b), and span check (FIG. 8c).

FIG. 8a shows the system during normal operation. The transceiver unit 5200 contains a laser 2000 and a detector 1000. The laser beam 2050 goes through the gas measurement volume 2060 twice. The retro-reflector 4050 is also illustrated.

FIG. 8b shows the zero check mode. In this mode the laser beam 2050 is directed via two mirrors 4400 directly to the detector 1000 avoiding all gas molecules that could absorb light. In this mode the reading from the instrument should be zero and the accuracy of the zero setting can therefore be checked.

FIG. 8c shows the span check mode. A reference cell 2070 containing a reference gas 2065 is automatically inserted into the beam. In this mode the length of the cell 2070 and the concentration of the reference gas will give the theoretical value that should be the result of the concentration measurement. The calibrations could therefore be verified by this method.

FIG. 9 shows the gas flow inside an extractive system configuration for use in an extractive analyzer 5300. The pipe or hose 5310 from the sample point is connected (see FIG. 6b) to the instrument and the gas led through a filter section 5380. The gas flow is initiated by a pump 5370. After the gas has passed the pump, it enters the multi-pass cell 5390 (see FIG. 7) where the measurement takes place. Reference numeral 5390 denotes the gas measurement cell in general. The lasers, mirrors, and detectors are not shown here. The gas exits the instrument through output 5350. The different parts or the complete analyzer 5300 are heated by heating elements 5360. The heating may be essential to avoid changes in the gas concentration, to avoid condensation and to avoid corrosion in the system.

The filter section 5380 removes particles from the gas and optionally moisture.

FIG. 10a shows the signal after process steps 7200, 7300, 7200 and 7300 in FIG. 11b. The signal is plotted for different concentrations of NH3 (ammonia). FIG. 10b shows one possible convolution function, the one used in generating FIGS. 10a-d. FIG. 10c shows the signal after convolution with the function in FIG. 10b for different concentrations. FIG. 10d shows the measured concentration of ammonia in a calibration cell purged with different concentrations of calibration gas. The calibration cell has been placed in the optical path of the set-up.

FIGS. 11a and 11b show the process steps of two possible methods for concentration measurement. In FIG. 11a an input signal 7000 is read from the data acquisition system. A fitted curve 7010 is subtracted from the signal in step 7100. One possible implementation is to use a line and the method of least squares. The signal after subtraction of the fitted curve is 7020 and this is fed into a low pass filter section 7200 before the derivative of the signal is found in step 7300. The signal is once more low pass filtered before the next derivative is found. Then the signal is convoluted in step 7400 before the peak of the curve is found and measured. The gas concentration is also calculated in step 7500.

The digital subtraction of the ramp in step 7100 in FIG. 11a) could be replaced by an analogue counterpart performed before the A/D conversion of the detector signal. The control unit 3000 could output a digital ramp signal adjusted to the current transmission, the digital output signal fed into a D/A converter and the analogue output of the D/A being fed into one of the differential inputs of the A/D converter, or being fed into one of the differential inputs of an amplification stage in front of the A/D converter. The detector signal being fed into the other differential input of the A/D-converter or amplifier respectively. Such an approach could reduce the requirements to resolution for the A/D converter.

FIG. 11b shows an alternative procedure similar to 11a except that in this case the subtraction of a fitted curve is omitted.

The gas monitor may be provided with mechanical shields in order to reduce the amount of ambient radiation reaching the detector. Lasers and detectors may be mounted together with other optics in a pipe/tube assembly which provides an outer encapsulation for these parts as well as screens for undesired light. See also FIGS. 2 and 4 for illustrations of the optical arrangement. In particular shields are arranged to avoid infrared radiation from parts that could have a high temperature. The outer house and optic tubes together with focusing ensures that very little light normally reaches the detector (field of view of the detection optics). Optical band pass filters could, however, be used to stop infrared (IR) radiation from gas or gas and dust when this has a high temperature. This reduces the risk of saturating the detector. Additionally, a DC-value could be subtracted in an amplifying stage in order to hold an analogue signal within the dynamic range. The modulation performed by the laser will together with an AC-coupling at the detector prevent that stray light will bring the electronics into saturation as long as the detector itself is not in saturation.

Referring now back to FIG. 1, the output of the A/D converter 1120 is connected to a data sampling circuit 3040 of a digital control unit 3000 implemented, for example, in field programmable gate array (FPGA) technology. The control unit is preferably based on ASIC, gate array, FPGA and/or analogue processor chips in order that several analogue or digital functions may be integrated into one or a few chips, thus reducing the number of discrete components in the system. As an example a FPGA from Altera Corporation, San Jose, Calif., USA could be used. In the control unit 3000 the data sampling circuitry 3040 is connected to a custom designed real time hardware processor 3050 and to an embedded microcontroller core 3010. The real time hardware processor 3050 and the microcontroller core 3010 are interconnected.

The A/D-converter 1120 has a high resolution in order to detect absorption of magnitude in the order of 10⁻⁵ to 10⁻⁶ of a DC signal. Preferably, a resolution of 20 bits or more is used in the A/D-converter, but 18 bit resolution has been found to be sufficient. The A/D-converter digitizes the signal and stores each scan in a buffer either for averaging of a multiple of scans or for use in a calculation of gas concentration. In order to reduce the requirement on the dynamics of the A/D converter, an analogue module could be inserted to subtract a low frequency (LF) ramp from the signal. To achieve this an extra D/A will have to be added which produces an LF ramp signal similar to the one being applied to the laser, possibly compensated for varying transmission due to dust, etc. The subtraction could be obtained using e.g. a differential input.

In the control unit 3000 the microcontroller 3010 is connected to a laser modulation circuitry 3030 for supplying control signals thereto, in order that the laser control circuit 3030 generates a digital output modulation signal to the input of D/A converter 2020. The output of the D/A converter is connected to a laser driver circuit 2010, for supplying to the laser diode 2000 an electrical current signal corresponding to the digital output modulation signal from the control unit 3000.

Also in the control unit 3000 there is provided a first I/O control circuit 3060 connected to an A/D converter 3550 and to a D/A converter 3560 for analogue input and analogue output, respectively. The first I/O control circuit 3060 is connected to the embedded microcontroller core 3010.

A second I/O control circuit 3020 is arranged as part of the control unit 3000. The second I/O control circuit is also connected to the microcontroller 3010. The second I/O control circuit 3020 is connected to the input of a D/A converter 2120, the output of which is connected to a heater/cooler driver 2110 which feeds the heater/cooler 2100 with an analogue drive current, such that in this arrangement the control unit 3000 is able to control the heater/cooler 2100. The heater/controller is preferably a thermoelectric cooling and heating device, e.g. a Peltier element. The heater/cooler 2100 is typically controlled by an electric control signal and a linear regulation of the heating/controlling function. The control signal could be a pulse width modulation signal where low pass filtering is obtained by the thermal characteristics of the mechanical construction, or the pulse width modulated signal could be low pass filtered in an analogue stage, using e.g. inductive or capacitive elements.

Further the second I/O control unit 3020 is connected to the output of an A/D converter 2420, the input of which is connected to a temperature sensor 2400, optionally via an amplifier section 2410. The temperature sensor 2400 is arranged for sensing the temperature of the laser 2000. The temperature sensor 2400 is preferably a thermistor. The thermistor could be coupled in a Wheatstone bridge arrangement, powered by the voltage reference of the A/D-converter, as illustrated in FIG. 5. A voltage reference would preferably also be used as a supply voltage for the A/D-converter in order to reduce noise and increase the accuracy of the temperature measurement. The temperature sensor is preferably coupled to the laser using a material with high thermal conductivity so that the temperature measured by the sensor is as close to the real laser temperature as possible. The combination of laser 2000, temperature sensor 2400 and heater/cooler 2100 thus provides a temperature regulation system which makes it possible to maintain the laser at a given temperature. Temperature regulation could be performed using either the microprocessor 3010 or by a special hardware function being a part of the hardware processor 3050. The regulation system preferably includes a PID regulator. In an alternative, the regulation system includes non-linear regulation. In yet another alternative, the laser temperature regulation system uses information on system specific characteristics pre-stored, for example in EEPROM/Flash module 3200, as part of the regulation system or provided via the control unit 3000 in order to improve the accuracy of the temperature regulation by including functionality to predict the responses of the laser system.

Additionally, the second I/O control unit 3020 of the control unit 3000 may be connected to a number of units external to control unit 3000. Such external units may comprise a RAM module 3100, an EPROM module 3200, a storage module 3300, a display module 3330, an Ethernet module 3350, as well as a radio link module 3360, the radio link module being connected to an antenna 3370.

In operation, computer programs realized in hardware and/or software in the control unit 3000 performs several functions adapted for providing the D/A converter 2020 supplying the laser driver circuit 2010 with a number of digital signals, such that appropriate drive signals are applied to the laser diode 2000.

One such function is to provide a drive signal which changes the wavelength of the laser according to a predefined pattern or according to algorithmic calculations based on constants or measured data. The predefined pattern or algorithms would typically be stored in the control unit itself or alternatively made accessible to the control unit by an external EEPROM or the like. This will be the same for virtually all program or data modules used by the control unit. Some or all of the program or data used during operation of the control unit will be provided either locally by the control unit itself or be supplied by external units, e.g. via a data communications bus. Such a wavelength change is obtained by changing the drive current of the laser. The intensity of the laser light changes when the current increases, however, the purpose is to change the wavelength. The increase in intensity is here an undesired secondary effect.

A second function of the control unit is to provide the laser diode with a drive signal which compensates the modulation intensity of the laser diode with regards to linear response of the laser output, e.g. wavelength tuning.

A third function of the control unit would be to optionally provide the laser diode with a drive signal having a high frequency modulation signal on top of a modulation of lower frequency, for possible use in yet more advanced processing of the detected signal. Thus, there may be contemplated a gas monitor with ramp current for laser with means to add a higher frequency component preferably a sine wave on top of said ramp and with means to utilise this higher frequency components for a digital counterpart of the analogue mixing done in gas monitors based on harmonic detection.

At the output of the laser diode 2000 there could be arranged a light dividing device, such as a beam splitter, fiber splitter or the like for supplying a portion of the output light to a reference detector. This reference detector could be used to generate a reference signal representing e.g. the laser output power. Typically this reference signal would be coupled back to the control unit 3000 via an input port and using a suitable A/D converter.

The gas monitor according to the invention will include signal processing capability, preferably within the control unit 3000, in order to convert the sampled signals. Primarily there is included processing functionality to convert the signal sampled by A/D converter 1120 into a value representing the concentration of the gas that is present in the gas measuring volume 2060, as illustrated in FIGS. 10 and 11. An averaging module could be provided in the program to average a multiple of signal acquisition scans in order to obtain an improved signal-to-noise ratio at the compromise of time resolution, whereby the averaged signal is made available for further processing. In an alternative an averaging module is adapted to calculate an average of several calculated measurements in order to improve signal-to-noise ratio using any method for averaging or filtering known to those skilled in the art, before presentation of the results.

Essentially the signal processing functions comprise gas absorption line detection from the measured signal, and a calculation of gas concentration based on the detected signal absorption line.

Optionally, the signal processing also comprises calculations for identification of frequency components that are present in the sampled signal for in combination with spectral information, i.e. gas absorption lines, to fully or partly calculate a gas concentration.

Different frequency components or the spectral properties of the sampled signal may be calculated using one or a combination of any of Fourier transforms (FT, FFT/DFT), discrete cosine transform (DCT) wavelets or any other transform apparent to those of ordinary skill in the art.

By providing an integrated solution according to this invention a highly efficient signal processing scheme is possible. In one alternative, an absorption line peak and width identification module is realized in hardware or software in the control unit 3000 with a program code which is adapted to fit a curve to the sampled signal data, to subtract the fitted curve from the signal and then filter or apply a convolution function on the signal, and then finally estimate the peak of the absorption line and convert this measurement into a gas concentration, as illustrated in FIGS. 10 and 11.

In yet an alternative, an absorption line peak and width identification module is realized in hardware or software in the control unit 3000 with a program code which is adapted to apply a filter function to the sampled signal, then to calculate the derivative of the intermediary result, then apply a second filter function, then to calculate the derivative once more and finally to measure the amplitude of the detected absorption peak in the signal and converting the resulting detected peak into a gas concentration.

Also in a further alternative, a digital signal mixing module is included in the control unit 3000 for replacing the mixing function performed by analogue mixers in traditional tuneable laser diode (TDL) monitors.

In yet another alternative the control unit 3000 is provided with a calibration function module and a data storage unit for the storage of calibration data, so that the gas monitor may perform a calibration using the built-in calibration functionality and stored calibration constants.

In a still further alternative the control unit 3000 could be provided with a wavelength tracking program module for tracking the wavelength of the laser using a detection of the wavelength of the absorption line peak in a sampled scan. In practice a measurement will yield a buffer/window of samples. The absorption line may be tracked and the corresponding sample number of the window/buffer will be a measure of the position of the absorption line. This will typically be a secondary result of most calculation algorithms for calculating a gas concentration. Hence a position is found, this position is compared with an allowable range, and readjustment of the laser wavelength is performed if the concentration is high enough to provide sufficient information. A readjustment is thus only performed if there is sufficient gas in the optical path. Such a wavelength tracking module could be set to operate only during conditions where a gas concentration is above a certain level. Alternatively, results obtained by the wavelength tracking module is used to adjust the laser using the laser drive circuit, thus reducing or substantially avoiding drift in the laser wavelength position.

In connection with the alternative just referred to, a gas monitoring apparatus according to the invention is directed to the detection of a possible first gas and a second gas being normally present, comprises an optical system as described above, adapted for scanning absorption lines of the first gas and the second gas respectively, whereby means is provided for utilizing at least one digital value related to the second gas, to provide tracking signals for the tuneable diode laser, thus to avoid wavelength drift thereof.

A further alternative is to include gain compensation. Gain compensation is achieved partly by analogue changes of the amplifier system and always digitally in the calculation of the concentration. A measurement of a direct signal has to be performed which is independent of the gas absorption and yields information on the amount of transmission present in the system, after the influence of dust on windows, in the path or possibly a change in detector response or emitted effect from the laser. Analogue change in the amplifier system is not required.

A zero setting function is optionally included in order to check and adjust a zero setting of the monitor. In some countries, like the US and other countries that have adopted regulations similar to the EPA, a requirement has been introduced into the legislation that the zero setting as well as the span is checked daily.

To achieve that, one can use a mirror arrangement in a dual path instrument and redirect the laser beam so that it never leaves the housing of the instrument. In the zero setting mode, the laser beam goes from the laser to the detector via the mirror arrangement passing no gas and there should no absorption, i.e. the reading should be zero. In span check mode a cell with a reference gas is inserted in the internal path. The measured concentration should correspond to the actual concentration in the cell. A sealed cell or a flow-through cell could be used. However, an automatic span check will often lead to deviations when aggressive gases, such as HF, NH3 are involved.

In connection with this invention it has been realized that a number of calculation methods can be used as part of the processing performed in the control unit 3000 in order to obtain a measure of the gas concentration. However, while one method of calculation may be preferable at low gas concentrations, another method may be preferable at high concentrations. Thus, to a person skilled in the art, it would be difficult to select the optimum calculation method for a given application. In this invention, however, the control unit 3000 is in one alternative embodiment provided with two or more calculation algorithms, and an algorithm choice and weighting scheme which, depending on a given or estimated gas concentration level, selects a set of one or more suitable algorithms to use and is able to combine the results of the different algorithms or calculation methods used. This could be performed by means of a simple averaging procedure or using a more complex weighting scheme wherein different weights are given to the result of different methods and the weights are made to depend on the estimated or measured gas concentration. Thus the method of calculation being used in each measurement situation depends on the gas concentration levels measured or expected in order to improve the speed or accuracy of the calculation, depending on what is most beneficial at the time.

However this approach could involve discontinuities if the concentration level is close to the limit. To compensate for this potential problem, the preferred embodiment of this aspect of the invention comprises means to weight the two different methods based on the varying concentration and to get a smooth transition from one method to another. The simplest implementation is that method 1 has weight 100% from 0 to concentration c1 and that the weight of method 1 linearly decreases to 0% at concentration c2. Method 2 has weight 0% from 0 to c1 where it linearly increases to 100% at c2. Above c2 the weight of method 2 is 100% and the weight of method 1 is 0%.

This approach could be expanded to cover more than 2 methods with a similar basis and other weighting functions could also be applied.

As indicated on FIG. 1 the laser source 2000 (transmitter unit) and the optical detector 1000 (receiver unit) are arranged as separate modules on either side of a measurement volume. Alternatively, the transmitter unit and receiver unit are collocated or combined in a single unit on one side of the measurement volume and a retro-reflector is placed on the opposite side of the measurement volume.

The monitor is in an alternative provided with an extractive or sampling system, as illustrated in FIG. 6, for extracting or sampling gas from an external volume into a gas measurement volume.

The optical arrangement in an alternative embodiment can be a multi-pass cell, as illustrated in FIG. 7, where the optical signal is reflected a multiple times through a measurement volume by using mirrors or optically reflecting surfaces. Such a multi-pass arrangement increases the total optical path length and improves the sensitivity to a gas concentration in the measurement volume. Alternatively, the optical arrangement is realized to give a white cell, i.e. a cell having diffuse reflection but otherwise similar to a Herriot cell, thus also increasing the effective optical path length and the sensitivity.

Another alternative of the present invention is to provide the monitor with receiving means for receiving and accommodating a gas reference cell in the optical path between the transmitter and receiver in order to check the calibration and the measurement span of the monitor using a gas of known characteristics.

In one version of this invention an optical bypass path is provided for permanently or periodically allowing some or most of the light from the laser to be transmitted to the detector in order to avoid transmission through the volume containing the gas to be measured, thus enabling a check on the zero setting of the monitor. This optical bypass path could be some form of light conduit, e.g. a light pipe running through the measurement volume or it could be an optical path separate from the measurement volume. FIG. 8b illustrates one example of how an optical bypass could be implemented. Mirrors 4440 direct the light from the laser 2000 to the detector 1000 without passing through the measurement volume 2060.

An alternative version of the invention comprises temperature compensation means based on a measurement of the temperature of the gas to be measured or monitored using e.g. a temperature sensor arranged at or in the gas measurement volume 2060. Pressure compensation could in an alternative version be provided by arranging a pressure sensor at the measurement volume. The outputs of the temperature and pressure sensors thus represent characteristics of the gas to be measured and are supplied to the control and signal processing unit 3000, typically via separate A/D converters. In this manner the control unit can be supplied with signals representing the temperature and pressure of in the gas of the gas measurement volume 2060 such that absorption line width broadening effects of pressure and temperature are taken into account during the processing of the detected signal such that the effects of temperature and pressure are compensated.

A particular aspect of this invention is directed to measuring the temperature and concentration of oxygen. The strongest O2 absorption band is located in the IR region around 760 nm. This band contains around 300 absorption lines. The total number of oxygen lines in all spectral ranges documented in the HITRAN database is approximately 6000.

We have found in connection with this invention that 4 oxygen absorption lines in the region from 760.04 to 760.10 are very well suited for measuring oxygen and the gas temperature simultaneously. For the temperature range up to around 500 degrees Celsius, referred to as the “low temperature” range in this specification, the lines at 760.069 and 760.096 is being used.

For the temperature range from around 300 to 1500 degrees Celsius, referred to here as the “high temperature” range, either the line at 760.069 or the line at 760.096 could be combined with one of the lines at either 760.043 or 760.048.

For the temperature range from 800 to 3000 degrees Celsius or higher, the “extra or very high temperature” range, the lines at 760.043 and 760.048 are used.

Thus, in general for this aspect the tuneable diode laser is adapted to scan across at least two absorption lines of the oxygen gas in the wavelength range from 760.04 to 760.10 nm.

Optical gas monitoring devices typically have windows or optical surfaces that face the process gas. In dirty atmospheres a volume in front of the window will be purged with clean compressed air or if the measurement could be influenced by the oxygen in the air, the windows will be purged with nitrogen. Some processes must be kept free of air and oxygen due to the risk of explosions and therefore need nitrogen purging. Nitrogen purging is normally expensive and in many applications only required due to interference from colder volumes of oxygen, i.e., it is difficult to measure the oxygen concentration and the temperature if the laser beam passes cold air from the purging system as well as high temperature process gas containing oxygen.

One advantage of using the line-pair at 760.043 and 760.048 nm for higher temperatures is that these lines are not present at lower temperatures and one can therefore use atmospheric air for purging without influencing the measurement of the temperature and the oxygen concentration.

This will keep the purging cost at the lowest possible level.

In one alternative additional gas sensors are included for measuring the presence of other gases than the gas of primary interest in order to enable compensation for the influence of such other gases on the line shape of the gas absorption line of interest.

Any of the sensors of temperature, pressure or additional gas is either spectroscopic sensors or any other standard sensor apparent for any person skilled in the art. A memory can be included for storing fixed values of gas temperature or pressure or the existence of other gases.

Typically, the gas monitor can also be equipped with display means or an information transfer unit for making the measurement results and status information from the gas monitor available to a user or an external device. The transfer means is in one alternative supplied via a current loop or as a voltage output where the current/voltage is proportional to the measured value or to the square root of the measurement value. Another alternative comprises transfer means based on a digital interface and a digital communication link over any medium apparent to a person skilled in the art, such as e.g. a copper wire, an optical fiber, a radio frequency channel, an open path for light. The display can typically be a character display or graphical display. In one alternative the display is included as part of the gas monitor itself or alternatively as a snap on device for attachment to the gas monitor.

Additional functionality can in yet another alternative be provided by the addition of an input device connected to the control unit 3000 such that a setting from an external source can be read by the gas monitor. In one alternative the input device can be a keyboard included as a part of the gas monitor or as a snap on device for attachment to the gas monitor.

The micro processor 3100 could run any operating system in combination with one or more application programs. Optionally only one application program could be running on the processor. The application program(s) could comprise web servers or any other servers communicating over the TCP/IP protocol or any other protocol. The purpose of these servers being to enable remote control of the monitor and to transfer data from and to the instrument.

In alternative embodiments of the invention the transfer means can be an RS232, an Ethernet, RF or any other communication medium and protocol apparent to those skilled in the art for communication with a PC (Personal Computer) or any other similar computing device apparent for a person skilled in the art. Such a computing device can alternatively be adapted to be a web server such that the measurement and status information can be made available to a user of the Internet, Intranet or local area network (LAN).

In one embodiment the invention comprises means to diagnose and test the various system components at power up and during normal operation. Such diagnostic and test means typically comprises voltage measuring circuits for measuring internal voltages, temperature sensors with associated circuitry to measure and regulate temperatures at or in vital parts or locations within the gas monitor. An optical laser power sensor can be connected so as to check the output of the laser diode. Test circuits can be included for checking the operation of the heater/cooler device.

Two or more absorption lines of a gas or gases contained in the gas measurement volume 2060 is for some gases or gas mixtures within the scan range of the tuneable laser diodes available today and in this case additional functionality will be included. By scanning the laser wavelength across one or more absorption lines in addition to the primary absorption line, i.e. the absorption line of the gas to be detected/measured, it is possible to identify and estimate two or more gas concentrations or alternatively one gas concentration and another property such as for example temperature by processing the detected signal in the control and signal processing unit 3000.

In a specific embodiment of the invention a first gas is H2S, a second gas is CH4 and a third gas preferably CO₂, that is normally present in the gas measurement volume, whereby three gas absorption lines are scanned in the same scan.

The gas monitor may in a further alternative be adapted to detect whenever a measured gas concentration is above an allowed maximum limit. By including a logging function or summing function a total gas exposure level is made available by using a signal processing function integrating the gas concentration versus time. Optionally, such gas levels or gas exposures are transmitted to external cooperation units. One option can be to transmit gas levels directly to public authorities for issuing penalties. Such a scheme can be an alternative in connection with emission monitoring for vehicles, ships, incinerators, power plants, etc.

FIG. 12 is an illustration of how the different modules illustrated in FIG. 1 could be grouped together or combined. Further, in FIG. 12 the control and processing unit 3000 is shown as an electronic circuit combining one microprocessor 3010 and one custom hardware logic circuit 3090. The peripheral equipment 3300, 3330, 3350, 3360 and 3370 are indicated by the dashed line as modules which could be separate modules, not necessarily included as parts of the core invention of this description. The I/O units for A/D and D/A 3550 and 3560 are combined in a combined analog I/O unit 3570 which normally not included in the core invention, either, but are illustrated to show how the gas monitor communicates with the outside world.

The combination of a microprocessor 3010 and custom hardware logic 3090 illustrated in FIG. 12 can according to this invention be implemented in two alternative versions.

In the first alternative version the custom hardware logic 3090 is realized as an ASIC/FPGA/GA in a circuit separate from the microprocessor 3010. In other words, in this embodiment of the invention the control and processing unit 3000 is a two-circuit/two-chip solution.

In the second alternative version the custom hardware logic 3090 and the microprocessor 3010 is realized as an ASIC/FPGA/GA with an embedded microprocessor, i.e. in this embodiment of the invention the control and processing unit 3000 is a one-circuit or one-chip solution.

A detector electronics unit 1150 can be realized as a single module accepting the detector output signal as an input and providing a digital output signal to the control and processing unit 3000. In other words, the connection between the detector electronics unit 1150 and the control and processing unit 3000 can be realized in digital technology.

The laser drive circuit 2010 and modulation circuit 2020 are combined in a laser control module 2030. This laser drive control module 2030 communicates digitally with the control and processing unit 3000 and provides an analogue output to the laser.

A laser heating element driver 2130 combines a D/A-converter 2120 with the heating element drive circuit 2110. In this way the heating element driver accepts digital input from the control and processing unit 3000 and provides an analogue output for the heating element 2100. The laser heating element driver 2130 communicates digitally with the control ad processing unit 3000. The laser heating element driver 2130 can be realized using a pulse width modulator in combination with an on/off switch. In an alternative an analogue low-pass filter can additionally be used, for example connected between the output of the switch and the heating element.

A laser temperature measurement module 2430 can be realized using a A/D converter 2420 and optionally an amplifier section 2410 for amplifying the signal from a temperature sensor 2400 prior to A/D-conversion in order that the control and processing unit 3000 is provided with a digital input representing the temperature of the laser 2000.

As in FIG. 1 the RAM 3100 and the EEPROM/Flash 3200 are illustrated in FIG. 12 as discrete components.

FIG. 12 thus illustrates an embodiment of this invention in which an ASIC/FPGA/GA circuit 3000 having custom hardware 3090 and an embedded microcontroller 3010 communicates digitally with a laser control module 2030, a laser heating element driver 2130, a laser temperature measurement system 2430 and a detector electronics unit 1150.

The detector electronics unit 1150 can in the simplest and most preferable version of the monitor according to this invention, consist of only an A/D converter 1120, but may in alternative embodiments of the invention additionally comprise an amplifying section 1110.

Parts of the RAM 3100 and the EEPROM/Flash 3200 can in some alternative embodiments of the invention be incorporated into the control and processing unit 3000.

As yet another alternative, one or more of the following modules can be included in a single ASIC of a mixed signal type, having analogue inputs and digital outputs: the combined analogue I/O unit 3570, the detector electronics unit 1150, the laser control module 2030, the laser heating element driver 2130 and the laser temperature measurement system 2430.

In another version one or more of the combined analogue I/O unit 3570, the detector electronics unit 1150, the laser control module 2030, the laser heating element driver 2130 and the laser temperature measurement system 2430 could be integrated in an ASIC-version of the control and processing unit 3000, whereby almost all control and signal processing functionality is included in this ASIC-circuit.

A malfunction module enables automatic reporting of a malfunctioning gas monitor to either the manufacturer or to the service partner.

An update module can be provided for enabling remote upgrading of the internal program (firmware).

A user interface can be provided, either simply for switching the monitor on off or to enable a more detailed input to the gas monitor from a user. Admission to use such a user interface could be protected, for example using a password system for access.

The user interface typically could comprise a small keyboard and a display. The display could be of LCD type, graphical or text, OLED (Organic Light Emitting Diode), or any other type. The user interface can be operated by software running in the microprocessor module 3100 and contains a menu system where the user can change settings like optical path length etc.

Instrument settings could also be changed using a PC and either a dedicated or custom “service software” package or a standard program such as a terminal emulator, telnet client or a web-browser. Some examples of communication between a PC and the instrument include RS232, RS422, RS485, USB, IEEE1394, Ethernet as well as wireless protocols.

For access via the Internet, the gas monitor comprises a web server for display current and historical readings (measurement results) to a user of the Internet.

Alternatively, current readings, measurement trends or historical data are directly or indirectly transmitted to cooperating parties or customers using SMS, e-mail or web-services.

In the description of this invention the term gas monitor has been used to a substantial extent. However, another term which could be used is gas analyzer or gas detector. Within the context of this applications the terms gas monitor, gas analyzer and gas detector or any other term used to describe similar gas measuring devices should be considered equivalent.

In the gas analysis business “ambient air” monitors will continuously monitor the air quality while “continues emission monitors” (CEM) will monitor emissions from such equipment as scrubbers, incinerators or stacks. Gas monitors will also be used to monitor gas concentration levels for process control applications in the industry. “Gas detectors” normally detect the presence of a gas that could be harmful or flammable and should give an alarm if the gas concentration is above a certain limit. Gas detectors could be portable or could be mounted fixed in brackets. In some parts of the world the term “gas analyser” is frequently used instead of “gas monitor”.

As already indicated above an important aspect of this invention relates to situations or operations where two or more gas types are of interest.

The safety risks in oil and gas fields as well as refineries are typically leaks of natural gas and hydrogen sulphide. Natural gas contains hydrocarbons, mainly methane (around 80%) but also ethane, propane, butane and other gases. Methane (CH₄) and the other hydrocarbons are potentially explosive gases. Hydrogen sulphide (H₂S) is poisonous and an unwanted by-product from oil and gas exploitation in many regions of the world. Because of safety considerations most oil and gas installations have installed both hydrocarbon and hydrogen sulphide detectors. Small concentrations of H₂S are normally difficult to detect reliably using other techniques than laser spectroscopy.

Spectroscopic gas monitors using one tuneable diode laser will normally not be able to measure more than one gas per laser. It has been a known possibility to use a number of laser diodes having different optical wavelengths, however, this has led to excessive costs and an undesirable increase in complexity of such gas monitoring devices.

Only methane absorption lines have been well documented in academic literature, while information on hydrogen sulphide absorption lines have not been published to a detail level required for spectroscopic use, i.e., only information on bands where H2S lines could exist has been available. To be able to implement this part of the invention it has been necessary to study available information on where CH4 lines are present as well as bands where H2S lines could be present. Detailed and extensive spectroscopic measurements as well as experiments with prototypes of the invention have been done to find combinations of absorption line pairs that will make it possible to measure both CH4 and H2S simultaneously.

In addition as an option already mentioned above, the gas monitor can be designed to scan across a third absorption line of a gas normally present in the atmosphere namely CO2. We have been able to find a CO2 line within the scan range of the laser so that all three lines will be scanned in the same scan, i.e., CH4, H2S and CO2. In this embodiment the CO2 will mainly be scanned to make sure that the actual scan range is kept within the absolute wavelength range that is required for detection of the explosive gas CH4 and the poisonous gas H2S.

Hence, in this aspect of this invention there is provided a gas monitor which enables monitoring of two different gases in a gas measurement volume by measuring a combination of two or more absorption lines using a single tuneable diode laser, an optical detector and the additional auxiliary hardware and software as described in the first part of this description. The requirement for this to work is that the tuneable range of the selected laser diode covers both absorption lines. The signal processing and concentration calculation will be the same for each absorption line as described above.

According to this invention there is provided a gas monitor based on tuneable diode lasers measuring both methane and hydrogen sulphide simultaneously, requiring only one laser and one detector. In one embodiment of this invention, a selected absorption line pair for CH₄ and H₂S may be used.

The combined CH₄ and H₂S gas monitor could be based on traditional techniques as described in the publication “Gas monitoring in the process industry using diode laser spectroscopy”, by I. Linnerud et al., in Applied Physics B, Lasers and Optics, B 67, pages 297-305, Springer-Verlag, 1998, or it could be based on the new configurations covered elsewhere in this patent text.

FIG. 13a shows a section of a simplified absorption spectrum 2064 with a first absorption line peak 2065 and a second absorption line peak 2066. The first absorption line peak 2065 at wavelength λ₁ belongs to gas number one and the second absorption line peak 2066 at wavelength λ₂ belongs to gas number 2. It is also illustrated how a laser line is scanned across both lines so that both gases can be measured in the same scan.

The laser is current modulated with a ramp function so that the laser wavelength is scanned across the wavelengths of the two absorption line peaks 2065 and 2066. The laser wavelength position is indicated for two current settings 2055 and 2056 along the ramp.

FIG. 13b shows two plots of the same absorption line for oxygen both at the same concentration 298.6 g/m3 and both at room temperature. The optical path length is 1 meter for both curves. The only difference is the pressure, normal atmospheric pressure for curve 2067 and 2 bars for curve 2068. The difference,is due to line broadening and as can be seen from FIG. 13b, the absorption line in curve 2068 is wider than in 2067, but the intensity of the peak is lower. However, the area under the two different curves 2067 and 2068 is equal. Many signal processing schemes used in particular in harmonic detection, ends up with a number that is close to be proportional to the intensity of the absorption peak in some way leading to measurement errors if the pressure changes slightly or if other gases are present. The figure illustrates the importance of taking line broadening into account when calculating a gas concentration. Normally the line width is measured as the “half width half max” (HWHM) or as the width at half max.

The shape of an absorption line could change depending on other factors than a change in gas concentration. The presence of another gas could lead to that the line becomes wider while the peak absorption decreases thus maintaining the area under the curve. This is difficult to measure using traditional harmonic detection where only the peak value is measured. However sampling the direct absorption using high resolution A/D converters and matching the sampled curve with simulated curves with different line broadening characteristics is performed to obtain a better measure for the line width. The measured curve is matched against reference templates based on calculated or previously measured data. In a case where the best match is in-between two templates an interpolation could be used to achieve a better result.

In some measurement applications one may want to use a separated transmitter 5000 and receiver 5100 configuration as shown in FIGS. 3a and 3b. This requires a distribution of the electronic parts, at least either the detector or the laser must be in another unit than the main electronics. This can be implemented using electrical signaling via an electrical cable 5500 or via optical cables 5550 or any other wave-guide for electromagnetic radiation.

The signaling between the electronics parts 3000 a) and 3000 b) is performed digitally so that the cabling functions as a transparent link between the parts placed in the transmitter 5000 and receiver 5100 modules, respectively.

Alternatively the complete electronics module 3000 (see FIG. 14) could be in either the transmitter module 5000 or the receiver module 5100 if at least the detector or the laser with associated electronics are placed in the opposite module.

The optical signaling can be done via optical fibers, plastic, multi-mode, single-mode or any other wave-guide including beams in open air. The transmitter could be an LED, a laser or any other light source.

The electrical signaling through electrical cables could be via single wires, wire pairs or via a group of pairs. Single wire voltage or current signaling as well as differrential voltage signaling could be used. Driver circuits 5504 and 5505 could comprise galvanic isolation to isolate electronics in the transmitter and receiver from each other.

FIG. 14 shows a solution optimized for a transmitter and receiver configuration where the digital electronics 3000 have been split into two parts 3000 a) and 3000 b). It might not be necessary to split the electronic module 3000 as long as at least either the laser or the detector system is in the opposite module. Digital communication between different parts, i.e., data buses etc is sent via communication lines 5500 (FIG. 14b) or 5550 (FIG. 14a). Line drivers and receivers 5504, 5505, 5554 and 5555 do the actual physical signaling.

FIG. 14a shows a communication link based on optical fibers 5552 in a cable 5550. Fibers 5552 could be multi-mode or single mode fibers or any other wave-guide for electromagnetic radiation. Optical transmitters 5554 send digital signals via the fibers to the receivers 5555. Transmitters could be based on LED, lasers or any other source of electromagnetic radiation.

FIG. 14b shows a communication link based on electrical signaling through a cable 5500 and via conductor wires, pair of wires or groups of pair of wires 5502. The signaling could be voltage signals, differential voltage signals, current signals or any other possible electrical signaling technique. Drivers or buffers 5504 generate the electrical signals that are transmitted from digital inputs. Signal detectors or converters detect the incoming signal and convert it to appropriate digital levels for the circuitry 3000a) and b).

FIG. 15 shows an implementation of the gas monitor electronics on one mixed signal application-specific integrated circuit (ASIC) 8000. Analogue electronics, A/D and D/A converters as well as digital circuits are integrated on the same chip. Parts of the total RAM 3100 and/or Flash memory 3200 are included in this ASIC 8000.

FIG. 16 shows an implementation using a mixed signal ASIC 8100 for A/D and D/A converters as well analogue electronics. The control unit 3000 could in the embodiment shown in this figure be implemented using either ASIC, gate array or FPGA technology.

As an alternative and inventive approach to calculating the concentration based on the sampled direct signal from the detector, convolution with a convolution function could be performed. FIG. 17(a and b) shows two convolution functions. FIG. 17a shows the same curve as shown in FIG. 10b and also shows the function used for calculating that curve. The purpose of the convolution is to enhance the absorption line so that the peak value of the absorption line can be fed into a function outputting the measured concentration. The selected convolution function should remove the DC level and suppress noise and maintain the absorption signal. The convolution function shown in FIG. 17b is one possible candidate.

1. Gas detection apparatus comprising,
an optical source unit including a tunable diode laser,
an optical detection unit including a light sensitive detector,
the source and the detector being arranged so that light from the source propagates through a gas measurement volume prior to being received by the detector, and the source being adapted to scan the light wavelength across one or more expected absorption lines of gases in the measurement volume,
a control and processing unit for control and modulation of the source and processing of the detected signal and for calculating at least one digital value representing (a) gas concentrations in the gas measurement volume,
wherein
said control and processing unit is coupled to the source via a digital-to-analogue (d/a) converter, and
the detector output signal is coupled to the input of an analogue-to-digital (a/d) converter, and the output of the a/d converter is coupled to the processing unit,
and the control and processing unit is adapted to perform essentially digital signal processing, and to calculate said at least one digital value taking into account the amplitude and the width of each gas absorption line detected:

2. Apparatus according to claim 1,
where the detector output is coupled directly to the analogue-to-digital converter.

3. Apparatus according to claim 1,
where the detector output is coupled to the analogue-to-digital converter via an amplifier.

4. Apparatus according to claim 1,
wherein the detector output signal is directly converted in the A/D converter into a digital signal representation, and all signal processing functions in said control and processing unit are performed in the digital domain.

5. Apparatus according to claim 1,
wherein said A/D-converter has a resolution of 18 bits or better.

6. Apparatus according to claim 1,
wherein the signal processor unit comprises one or more processing devices from a group consisting of ASICs (Application Specific Integrated Circuits), gate arrays, FPGAs (Field Programmable Gate Arrays) and analogue processor chips.

7. Apparatus according to claim 1,
wherein the signal processor unit comprises a modulation unit for enabling a change in the intensity of the laser output light according to a predefined pattern or according to algorithmic calculations.

8. Gas monitor comprising,
a tunable laser diode source,
an optical detector,
whereby said source and said detector are arranged so that light from the laser diode propagates through a gas measurement volume prior to being received by the optical detector
an integrated circuit (IC) for controlling said tunable laser diode and for processing signals provided by said optical detector,
said IC being adapted to provide, at an output port, a digital output signal for control of the laser diode, and
said IC being adapted to receive, at an input port, a second digital input signal representing a detection signal provided by the detector,
the IC being further adapted to calculate a digital value representing a gas concentration in the gas measurement volume, and
wherein a digital-to-analogue (D/A) converter is connected with its input to said output port of the IC and its output is connected directly to said tunable optical source, and
an analogue-to-digital (A/D) converter is connected with its input to the output of the optical detector and with its output to said input port of the IC.

9. Gas monitor comprising,
a tunable diode laser source,
a light sensitive detector,
the source and the detector being arranged so that light from the source propagates through a gas measurement volume prior to being received by the detector, wherein
a custom hardware logic circuit is provided for control and modulation of the source and processing of the detected signal and for calculating a digital value representing a gas concentration in the gas measurement volume, and
said custom hardware logic circuit is coupled to the said source using a digital-to-analogue (D/A) converter, and the detector output signal is coupled to the input of an analogue-to-digital (A/D) converter, and the output of the said A/D converter is coupled to said custom hardware logic circuit.

10. Gas monitor according to claim 9,
wherein a microprocessor is embedded in an integrated circuit together with said custom hardware logic circuit.

11. Gas monitor according to claim 9,
wherein a microprocessor in the form of an auxiliary integrated circuit, is arranged separately from said custom hardware logic circuit for assisting the control and processing functionality of the gas monitor.

12. Gas monitoring apparatus, in particular for safety and alarm purposes, based on optical spectroscopy for the detection of a possible first gas i.e. H2S and a possible second gas i.e. CH4, in a gas measurement volume, comprising
an optical source including one tunable diode laser,
an optical detection unit including one light detector,
said source and said detector being arranged so that light from the source propagates through said volume before falling on said detector,
wherein said diode laser is adapted to scan an absorption line of said first gas and an absorption line of said second gas in a single or double wavelength scan comprising wavelengths in the range from 1590 to 1610 nm,
and a control and processing unit is provided for the control and modulation of the source and processing of a detected signal from said detector and for calculating digital values representing the concentration of said first gas and said second gas, respectively, in the gas measurement volume.

13. Gas monitoring apparatus based on optical spectroscopy for the detection of a possible first gas and a second gas being normally present in a gas measurement volume, comprising
an optical source including one tunable diode laser,
an optical detection unit including one light detector,
said source and said detector being arranged so that light from the source propagates through said volume before falling on said detector,
wherein said diode laser is adapted to scan an absorption line of said first gas and an absorption line of said second gas in a single or double wavelength scan,
a control and processing unit is provided for the control and modulation of the source and processing of a detected signal from said detector and for calculating digital values representing the concentration of said first gas and said second gas, respectively, in the gas measurement volume,
and non-spectroscopic means is provided for measurement of said second gas, thereby verifying the spectroscopic measurement of the second gas.

14. Apparatus according to claim 12,
wherein the control and processing unit is adapted to perform essentially digital signal processing, and to calculate at least one digital value taking into account the amplitude and the width of each gas absorption line detected.

15. Gas monitoring apparatus based on optical spectroscopy for the detection of a possible first gas and a second gas being normally present in a gas measurement volume, comprising
an optical source including one tunable diode laser,
an optical detection unit including one light detector,
said source and said detector being arranged so that light from the source propagates through said volume before falling on said detector,
wherein said diode laser is adapted to scan an absorption line of said first gas and an absorption line of said second gas in a single or double wavelength scan,
a control and processing unit is provided for the control and modulation of the source and processing of a detected signal from said detector and for calculating digital values representing the concentration of said first gas and said second gas, respectively, in the gas measurement volume,
and means is provided for utilizing one of said digital values related to said second gas, to provide tracking signals for the tunable diode laser, thus to avoid wavelength drift thereof.

16. Gas measurement apparatus based on optical spectroscopy for measuring the temperature and concentration of oxygen in a gas volume, comprising
an optical source including one tunable diode laser,
an optical detection unit including one light detector,
said source and said detector being arranged so that light from the source propagates through said volume before falling on said detector,
wherein said tunable diode laser is adapted to scan across at least two absorption lines of the oxygen gas in the wavelength range from 760.04 to 760.10 nm,
and a control and processing unit is provided for the control and modulation of the source and processing of a detected signal from said detector and for calculating digital values representing said oxygen concentration and temperature.

17. Apparatus according to claim 15,
wherein the control and processing unit is adapted to perform essentially digital signal processing, and to calculate at least one digital value taking into account the amplitude and the width of each gas absorption line detected.

18. Apparatus according to claim 16, where
said tunable diode laser is adapted to scan across an absorption line pair at wavelengths of 760.096 nm and 760.069 nm, respectively, for low temperature measurement of oxygen and temperature.

19. Apparatus according to claim 16, where
said tunable diode laser is adapted to scan across an absorption line pair at wavelengths of 760.043 nm and 760.048 nm, respectively, for very high temperature measurement of oxygen and temperature.

20. Apparatus according to claim 16, where
said tunable diode laser is adapted to scan across an absorption line pair at wavelengths of 760.096 nm and 760.048 nm, respectively, for high temperature measurement of oxygen and temperature.

21. Apparatus according to claim 16, where
said tunable diode laser is adapted to scan across an absorption line pair at wavelengths of 760.096 nm and 760.043 nm, respectively, for high temperature measurement of oxygen and temperature.

22. Apparatus according to claim 16, where
said tunable diode laser is adapted to scan across an absorption line pair at wavelengths of 760.069 nm and 760.048 nm, respectively, for high temperature measurement of oxygen and temperature.

23. Apparatus according to claim 16, where
said tunable diode laser is adapted to scan across an absorption line pair at wavelengths of 760.069 nm and 760.043 nm, respectively, for high temperature measurement of oxygen and temperature.

24. Apparatus according to claim 1,
comprising electronics modules associated with said optical source and said optical detection unit, respectively, said optical source being arranged as part of a transmitter module and said optical detection unit being arranged as part of a receiver module, said transmitter and receiver modules being arranged at spaced apart positions and interconnected by digital communication means.

25. Apparatus according to claim 24,
wherein the digital communication means comprises at least one optical fiber between digital electronics modules in said transmitter and in said receiver, respectively.

26. Apparatus according to claim 24,
wherein the digital communication means comprises at least one electrically conducting wire between digital electronics modules in said transmitter and in said receiver, respectively.

27. Apparatus according to claim 12,
wherein the tunable laser diode is a DFB-type or VCSEL-type laser.

28. Apparatus according to claim 12,
wherein said diode laser additionally is adapted to scan an absorption line of a third gas, e.g. CO₂, that is normally present in the gas measurement volume, whereby three gas absorption lines are scanned in the same scan.

29. Method for gas detection in a measurement volume, comprising the steps of
launching light into said measurement volume using a tunable diode laser source,
detecting and converting a part of the light from said source having propagated through a part of the measurement volume into an electronic signal using an optoelectronic detector,
converting said electronic signal into a digital signal using an analogue-to-digital (A/D) converter,
processing said digital signal into a signal representative of gas characteristics of said measurement volume using a signal processor unit, and
determining said representative signal at least in part on the basis of the amplitude and the width of each absorption line detected in the gas.

30. Method for gas detection in a measurement volume comprising, the steps of
providing a modulation and control signal to a tunable diode laser source using a control and signal processing unit and a digital-to-analogue converter,
directing light from said laser source into the measurement volume,
detecting and converting into an electronic signal a part of the light from said source using a light sensitive detector, said part having propagated through a part of said measurement volume
providing a digital representation of said electronic signal to said control and signal processing unit using an analogue-to-digital (A/D) converter,
processing said digital representation in the control and signal processing unit in order to generate digital code representing at least one value related to the gas fraction contents of said measurement volume, and
said at least one value being determined at least in part on the basis of the amplitude and the width of each absorption line detected in the gas.

31. Method according to claim 29, wherein
wavelength scanning of said tunable diode laser is performed across at least two absorption lines for at least two different gases.

32. Method according to claim 31, wherein
said scanning is performed across at least two absorption lines for methane (C4H) and hydrogen sulphide (H2S), preferably in the range of 1590 to 1610 nm.

33. Method according to claim 29, wherein
normally present in the measurement volume, whereby tracking, adjustment or calibration of said tunable diode laser and/or said processing unit is made possible.

34. Method according to claim 29, wherein
wavelength scanning of said tunable diode laser is performed across three absorption lines for three different gases, two of said three gases being preferably methane (C4H) and hydrogen sulphide (H2S), a third gas being a type of gas that is normally present in the measurement volume.

35. Gas detection apparatus comprising,
an optical source unit including a tuneable diode laser,
an optical detection unit including a light sensitive detector,
the source and the detector being arranged so that light from the source propagates, through a gas measurement volume prior to being received by the detector, and the source being adapted to scan the light wavelength across one or more expected absorption lines of gases in the measurement volume,
a control and processing unit for control and modulation of the source and processing of the detected signal and for calculating at least one digital value representing gas concentrations in the gas measurement volume,
wherein
said control and processing unit is coupled to the source via a digital-to-analogue (D/A) converter, and
the detector output signal is coupled to the input of an analogue-to-digital (A/D) converter, and the output of the A/D converter is coupled to the processing unit,
and the control and processing unit is adapted to perform essentially digital signal processing, a first step of calculation being convolution with a suitable convolution function to remove the DC-level, suppress noise and to enhance each gas absorption line
a second step being to convert the peak value of each absorption line into a gas concentration.
